(19) United States
(12) Patent Application Publication
(10) Pub. No.: US 2025/0135698 A1
(43) Pub. Date: May 1, 2025

(54) MOLDING MANAGEMENT SYSTEM

(71) Applicant: SEIKO EPSON CORPORATION, Tokyo (JP)

(72) Inventors: Kosuke ATSUTA, SHIOJIRI-SHI (JP); Yusuke MITSUMA, SHIOJIRI-SHI (JP); Soji SHIOZAWA, MATSUMOTO-SHI (JP)

(21) Appl. No.: 18/931,925

(22) Filed: Oct. 30, 2024

(30) Foreign Application Priority Data
Nov. 1, 2023 (JP) 2023-187795

(51) Int. Cl. B29C 45/76; B29C 37/00

(52) U.S. Cl. CPC B29C 45/762; B29C 2037/903; B29C 2037/906; B29C 2045/7606; B29C 2945/76076; B29C 2945/7617

(57) ABSTRACT

A molding management system including a server and managing production of a product in a production process including an injection molding process of the product by an injection molding device, wherein the server is communicably connected to a terminal device and configured to cause the terminal device to display production plan information indicating a production plan for a designated first product in response to an operation received from the terminal device and the production plan information includes first operating time period information indicating a first operating time period in which the injection molding device is operated to produce the first product and inoperable time period information indicating at least an inoperable time period during which the injection molding device cannot be operated to produce the first product.

The present application is based on, and claims priority from JP Application Serial Number 2023-187795, filed Nov. 1, 2023, the disclosure of which is hereby incorporated by reference herein in its entirety.

### BACKGROUND

### 1. Technical Field

This disclosure relates to a molding management system.

### 2. Related Art

Research and development have been conducted on a technique for managing the production of a product in a production process including an injection molding process of the product by an injection molding device using a material containing metal powder.

In this regard, a production plan drafting program is known which causes a computer to draft a production plan for a production process based on information indicating the quantity of a target product to be produced in a certain production process, information indicating the ability to produce a target product in the production process, and the like (see JP-A-2006-018576).

However, although the production plan drafting program described in JP-A-2006-018576 is necessary for the production of the target product such as the preparation time for causing the injection molding device to perform the injection molding process, the production planning program cannot include the time during which the target product cannot be produced and the time during which the target product cannot be use produced because the time is assigned to the production of another product, and thus a highly accurate production plan cannot be prepared.

### SUMMARY

In order to solve the above problem, one aspect of the present disclosure is a molding management system including a server and managing a production of a product by an injection molding device, the molding management system includes the server is communicably connected to a terminal device and configured to cause the terminal device to display production plan information indicating a production plan for a designated first product in response to an operation received from the terminal device and the production plan information includes first operating time period information indicating a first operating time period in which the injection molding device is operated to produce the first product and inoperable time period information indicating at least an inoperable time period during which the injection molding device cannot be operated to produce the first product.

### BRIEF DESCRIPTION OF THE DRAWINGS

FIG. 1 is a diagram showing an example of a configuration of a molding management system 1.

FIG. 2 is a diagram showing an example of a main menu image P1.

FIG. 3 is a diagram showing an example of a terminal image P2.

FIG. 4 is a diagram showing an example of a production plan creation image P3.

FIG. 5 is a diagram showing an example of a state in which a pull-down menu is displayed in an input field F14.

FIG. 6 is a diagram showing an example of a state in which injection molding device identification information is input to an input field F16 and thus standard cycle time information is input to an input field F26.

FIG. 7 is a diagram showing an example of a state in which metal mold identification information is input to an input field F17 and thus number of cavities information is input to an input field F18.

FIG. 8 is a diagram showing an example of a production planning start time reception image CL displayed on a production plan creation image P3.

FIG. 9 is a diagram showing an example of the production planning start time reception image CL in an initial state.

FIG. 10 is a diagram showing an example of when all the information of the input field F13 to the input field F22 is input, a message displayed on the production plan creation image P3.

FIG. 11 is a diagram showing an example of the production plan creation image P3 after a selection operation at a button B31 and a plotting to a graph GP are performed.

FIG. 12 is a diagram showing an example of the production plan creation image P3 when an error message MG2 is displayed.

FIG. 13 is a diagram showing an example of a reception image P4 displayed on the production plan creation image P3.

FIG. 14 is a diagram showing an example of the reception image P4 immediately after a target designated time period is designated as a preparation time period.

FIG. 15 is a diagram showing an example of the reception image P4 immediately after unit time production quantity information is input to an input field F33.

FIG. 16 is a diagram showing an example of the reception image P4 immediately after the target designated time period is changed from a 19th time period to a 20th time period in the reception image P4 shown in FIG. 15.

FIG. 17 is a diagram showing an example of the production plan creation image P3 in a state where a button B33 is displayed.

FIG. 18 is a diagram showing an example of an inoperable time period reception image P5.

FIG. 19 is a diagram showing a state in which second operating time period information is displayed on the graph GP and a state in which the second operating time period information is displayed on a graph GP2.

FIG. 20 is a diagram showing an example of a hardware configuration of a server 30.

FIG. 21 is a diagram showing an example of a functional configuration of the server 30.

FIG. 22 is a diagram showing an example of a flow of process in which the server 30 generates production plan information.

### DESCRIPTION OF EMBODIMENTS

### Embodiment

Hereinafter, embodiments of the present disclosure will be described with reference to the drawings.

### Overview of Molding Management System

First, an outline of the molding management system according to the embodiment will be described.

A molding management system according to the embodiment manages the production of the product in a production process including an injection molding process of the product by an injection molding device. The molding management system includes a server. The server is communicably connected to a terminal device and is configured to cause the terminal device to display production plan information indicating a production plan for a designated first product in response to an operation received from the terminal device. The production plan information includes first operating time period information indicating a first operating time period in which the injection molding device is operated to produce the first product and inoperable time period information indicating at least an inoperable time period during which the injection molding device cannot be operated to produce the first product.

By this, the molding management system according to the embodiment can provide a production plan with higher accuracy as compared with a production plan that does not include the time period indicated by the inoperable time period information.

Hereinafter, each of the configurations of the injection molding system according to the embodiment and the process performed by the server included in the injection molding system will be described in detail.

### Configuration of Molding Management System

Hereinafter, the configuration of the molding management system according to the embodiment will be described using a molding management system 1 as an example.

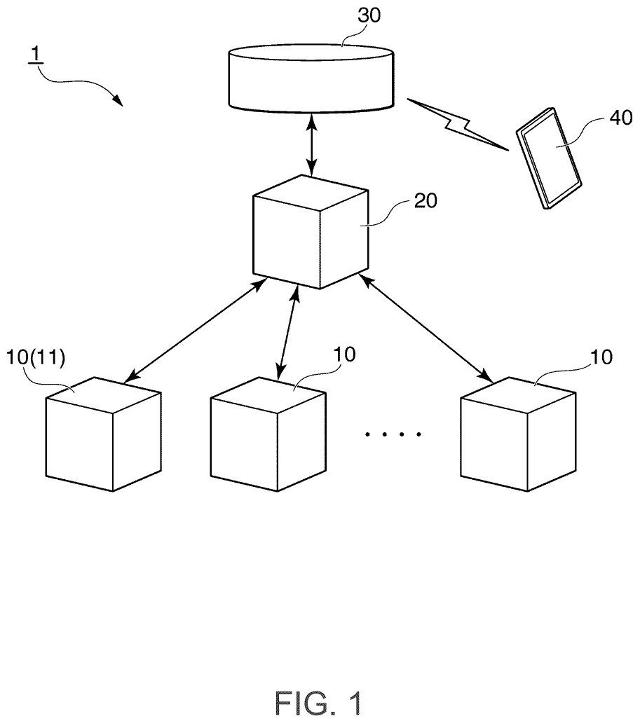

FIG. 1 is a diagram showing an example of a configuration of the molding management system 1.

The molding management system 1 is a kind of Manufacturing Execution System (MES). For example, the molding management system 1 includes one or more managed devices 10, an information process device 20, and a server 30. Note that the molding management system 1 may be configured not to include part or all of one or more managed devices 10. The molding management system 1 may have a configuration that does not include the information process device 20. Hereinafter, as an example, a case will be described in which the molding management system 1 includes a plurality of managed devices 10 as one or more managed devices 10.

Each of the plurality of managed devices 10 included in the molding management system 1 is a device managed by the molding management system 1. In FIG. 1, each of the managed devices 10 is indicated by the same reference symbol for convenience of explanation. However, some or all of the managed devices 10 may be different types of devices. The plurality of managed devices 10 include at least one injection molding device for performing metal powder injection molding Metal Injection Molding (MIM) of the product. An injection molding device 11 shown in FIG. 1 is an example of such an injection molding device. Hereinafter, for convenience of description, metal powder injection molding will be referred to as simply injection molding and described. Note that the plurality of managed devices 10 include, for example, peripheral equipment and the like of the injection molding device in addition to the injection molding device. The peripheral equipment of the injection molding device includes, for example, a material supply device for supplying the injection molding device with material used in injection molding of the product by the injection molding device, a transport device for transporting the product of injection molding by the injection molding device, a cleaning device for cleaning the product of injection molding by the injection molding device, a sintering device for sintering the product after being cleaned by the cleaning device, and the like, but is not limited thereto. At least one injection molding device included in the plurality of managed devices 10 may be a machine for performing injection molding using a material other than metal.

The molding management system 1 manages the production of the product in the production process, which includes the injection molding process of the product by the injection molding device included in the plurality of managed devices 10. Here, each injection molding device included in the plurality of managed devices 10 may have any configuration as long as it is capable of producing the product by injection molding. Hereinafter, for convenience of description, one injection molding of the product by the injection molding device will be referred to as one shot and described. In this case, for example, two shots means injection molding of the product twice by the injection molding device.

The information process device 20 acquires, for each of the plurality of managed devices 10, state information indicating the state of the managed device 10 from the managed device 10. For example, the information process device 20 acquires the state information for the injection molding device 11 from the injection molding device 11. Such state information includes a time stamp indicating the date and time when the state information was acquired by the information process device 20. Certain state information includes device identification information for identifying the managed device 10 in a state indicated by the state information. Such acquisition of the state information by the information process device 20 may be performed periodically or non-periodically. Hereinafter, as an example, a case where the state information is acquired by the information process device 20 every time the one shot described above is performed will be described. When certain state information is acquired, the information process device 20 outputs the acquired state information to the server 30. By this, the information process device 20 can store the acquired state information in the server 30.

The information process device 20 is, for example, a workstation, a desktop Personal Computer (PC), a notebook PC, or the like, but is not limited thereto. The information process device 20 is communicably connected to each of the plurality of managed devices 10 via wired or wireless communication. A communication network for connecting the information process device 20 and each of the managed devices 10 is, for example, a Local Area Network (LAN) in a facility where multiple managed devices 10 are installed, but is not limited thereto. The communication network may be another communication network such as the Internet or a mobile communication network.

The server 30 stores the state information acquired by the information process device 20. For example, when the server 30 acquires certain state information from the information process device 20, the server 30 stores the acquired state information. Here, when the server 30 has already stored the state information including the device identification information included in the state information, the server 30 replaces the already stored state information with the newly acquired state information. By this, the server 30 can always keep the state information indicating the state of the managed device 10 indicated by the device identification information to be the latest state information. Note that the server 30 may be configured to store all the acquired state information without performing such a replacement. The server 30 may be configured so that, even when such a replacement is performed, it newly stores the state information before the replacement as the history information indicating the history of the state of the managed device 10.

In response to a request from the terminal device communicably connected to the server 30, the server 30 causes a display section of the terminal device to display various images based on the state information stored in the server 30. Hereinafter, as an example, a case where the server 30 is communicably connected to a terminal device 40 as shown in FIG. 1 will be described below. Note that in the present embodiment, the process relating to the login to the server 30 by the terminal device 40 is a known process, and therefore, the description thereof will be omitted. Hereinafter, for convenience of description, the server 30 receiving an operation from the terminal device 40 via the image displayed on the terminal device 40 will be simply referred to as the server 30 receiving an operation and described. That is, in the following description, the server 30 performs a certain process in response to the received operation means that the server 30 performs the process in response to the operation received from the terminal device 40 via the image displayed on the terminal device 40.

The server 30 receives various kinds of information according to the received operation. For example, the server 30 stores master data including various kinds of information for the product produced by the injection molding device 11 according to the received operation. The master data includes, for example, product identification information for identifying various products produced by the injection molding device 11, production quantity planned value information indicating the planned value of the production quantity of the product identified by each product identification information, metal mold identification information for identifying a metal mold used to produce the product identified by each product identification information, and the like. The data structure of the master data may be any structure. For example, various kinds of information included in the master data are included in the master data as information associated with the product identification information.

In response to the received operation, the server 30 causes the display section of the terminal device 40 to display the production plan information indicating the production plan for the first product designated by the operation. The display section is, for example, the display of the terminal device 40, a display device communicably connected to the terminal device 40, or the like, but is not limited thereto. Hereinafter, as an example, a case where the display section is the display of the terminal device 40 will be described. Hereinafter, for convenience of description, displaying a certain image on the display section will be referred to as displaying the image on the terminal device 40 and described.

Here, the production plan information includes the first operating time period information indicating an operating time period in which the injection molding device is operated to produce the first product and the inoperable time period information indicating at least an inoperable time period during which the injection molding device cannot be operated to produce the first product. By this, the server 30 can provide a highly accurate production plan for the production of the first product to the user of the terminal device 40. Note that the production plan information is, for example, a graph in which a histogram indicating the planned value of the production quantity of product to be produced by the injection molding device in each time period included in the operating time period is plotted as operating time period information and the inoperable time period information is displayed, but the production plan information is not limited to this and may be information in another format including the operating time period information and the inoperable time period information. The histogram is an example of first operating time period information and an example of production quantity information.

The server 30 displays such production plan information on the terminal device 40 in response to the operation received from a production plan creation image via the terminal device 40. The production plan creation image is an image for receiving the operation for generating the production plan information.

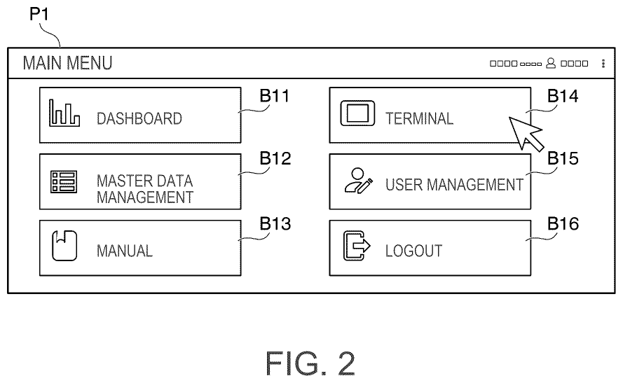

For example, by receiving the operation via a main menu image P1 as shown in FIG. 2, the server 30 displays the production plan creation image on the terminal device 40. FIG. 2 is a diagram showing an example of the main menu image P1.

When the server 30 receives a predetermined main menu image display operation, it causes the terminal device 40 to display the main menu image P1. In the example shown in FIG. 2, the main menu image P1 includes six buttons of button B11 to button B16.

The button B11 is a button for displaying a dashboard image. When the server 30 receives operation of the button B11 via the terminal device 40, the server 30 generates the dashboard image and causes the terminal device 40 to display the generated dashboard image. Here, the dashboard image is an image on which is displayed information necessary for the user to manage the production of the product by the injection molding device during the operation of the injection molding device designated by the user of the terminal device 40.

The button B12 is a button for displaying a master data management image. When the server 30 receives operation of the button B12 via the terminal device 40, the server 30 generates the master data management image and causes the terminal device 40 to display the generated master data management image. Here, the master data management image is an image that receives the operation of inputting, changing, deleting, or the like of the master data described above. The server 30 can perform generation, changing, deleting, and the like of the master data according to the operation on the master data management image via the terminal device 40. When the server 30 generates the master data, the server 30 stores the generated master data. When the master data is changed, the server 30 updates the stored master data to the changed master data.

The button B13 is a button for displaying a manual image. When the server 30 receives operation of the button B13 via the terminal device 40, the server 30 generates the manual image and causes the terminal device 40 to display the generated manual image. Here, the manual image is an image that receives the operation for displaying a manual on an operation method of the molding management system 1.

The button B14 is a button for displaying a terminal image P2. When the server 30 receives operation of the button B14 via the terminal device 40, the server 30 generates the terminal image P2 and causes the terminal device 40 to display the generated terminal image. Here, the terminal image P2 is an image that receives the operation for executing each of various update functions included in the server 30. Certain type of update function is a function of inputting, changing, deleting, and the like of information corresponding to the type.

The button B15 is a button for displaying a user management image. When the server 30 receives operation of the button B15 via the terminal device 40, the server 30 generates the user management image and causes the terminal device 40 to display the generated user management image. Here, the user management image is an image for receiving the operation of performing inputting, changing, deleting, displaying, or the like of information relating to the user among the information stored in the server 30.

The button B16 is a button for receiving an operation of logging out the terminal device 40 from the server 30. When the server 30 receives operation of the button B16 via the terminal device 40, the server 30 causes the terminal device 40 to log out.

Note that in the present embodiment, the description of each of the dashboard images, the master data management image, the manual image, and the user management image will be omitted.

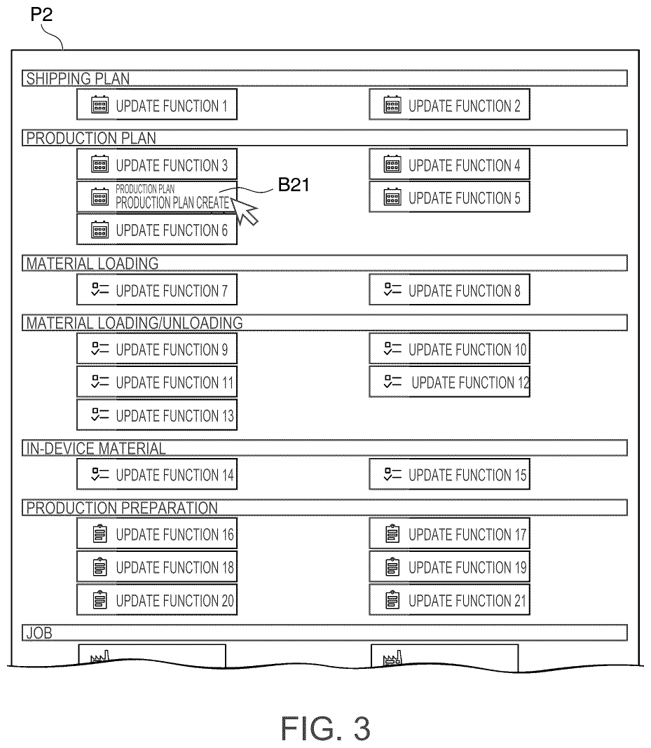

FIG. 3 is a diagram showing an example of the terminal image P2. As shown in FIG. 3, the terminal image P2 includes a button for receiving the operation for executing each of the plurality of update functions. One button among such a buttons is a button B21.

The button B21 is a button for receiving an operation of displaying a production plan creation image P3, which is an example of the production plan creation image described above. When the server 30 receives the operation at the button B21 via the terminal device 40, the server 30 generates the production plan creation image P3 and causes the terminal device 40 to display the generated production plan creation image P3.

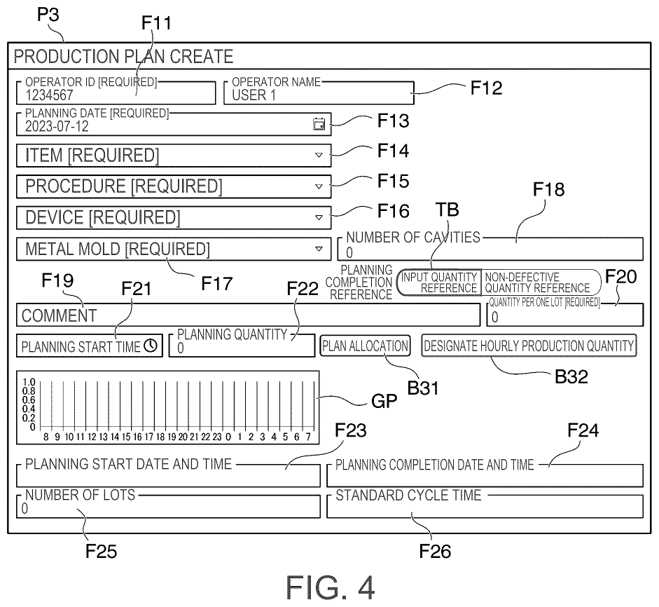

FIG. 4 is a diagram showing an example of the production plan creation image P3. In the example shown in FIG. 4, the production plan creation image P3 includes 26 input fields of input field F11 to input field F26, a toggle switch TB, a graph GP, a button B31, and a button B32. Note that the production plan creation image P3 may be configured to include another Graphical User Interface (GUI) instead of some or all of the 26 input fields from the input field F11 to the input field F26, the toggle switch TB, the graph GP, the button B31, and the button B32, or in addition to all of the 26 input fields from the input field F11 to the input field F26, the toggle switch TB, the graph GP, the button B31, and the button B32.

The input field F11 is a field in which user identification information for identifying the user is input. In FIG. 4, “USER ID”, which is a character string superimposed on the input field F11, is a character string for indicating to the user that the information input to the input field F11 is the user identification information. In the example shown in FIG. 4, “1234567” is input to the input field F11 as the user identification information.

The input field F12 is a field in which user name information indicating the name of the user is input. In FIG. 4, “USER NAME”, which is a character string superimposed on the input field F12, is a character string for indicating to the user that the information input to the input field F12 is the user name information. In the example shown in FIG. 4, “USER 1” is input to the input field F12 as the user name information.

The input field F13 is a field in which production planning start date information indicating a date desired by the user as a production planning start date for starting the production plan for the production of the product is input. That is, the production planning start date indicated by the production planning start date information input to the input field F13 is a date for starting the production plan indicated by the production plan information generated in the production plan creation image P3. In FIG. 4, “PLANNING DATE”, which is a character string superimposed on the input field F13, is a character string for indicating to the user that the information input to the input field F13 is the production planning start date information. In the example shown in FIG. 4, “2023 Jul. 12” is input to the input field F13 as the production planning start date information. This indicates that the production planning start date indicated by the production planning start date information input into input field F13 is Jul. 12, 2023. Hereinafter, for convenience of description, the production planning start date indicated by the production planning start date information input to the input field F13 will be referred to as a target production planning start date and information indicating the target production planning start date will be referred to as target production planning start date information and described.

The input field F14 is a field in which product type information indicating a type of product to be produced by the injection molding device is input. In FIG. 4, “ITEM”, which is a character string superimposed on the input field F14, is a character string for indicating to the user that the information input to the input field F14 is the product type information. In the example shown in FIG. 4, nothing is inputted in the input field F14. Hereinafter, for convenience of description, the product of the type indicated by the product type information input to the input field F14 will be referred to as a target product and information indicating the target product will be referred to as target product information and described.

The input field F15 is a field in which a procedure information indicating a procedure including the injection molding process of the target product by the injection molding device is input. In FIG. 4, “PROCEDURE”, which is a character string superimposed on the input field F15, is a character string for indicating to the user that the information input to the input field F15 is the procedure information. In the example shown in FIG. 4, nothing is inputted in the input field F15. Here, the procedure is an order of a plurality of processes. The plurality of processes includes, for example, the injection molding process, a secondary processing process, an inspection process, a packaging process, and the like, but is not limited thereto. The secondary processing process is gate cut annealing, deburring, and the like. The procedure information input to the input field F15 may be information indicating the procedure by a name such as “PROCEDURE A”, “MOLDING PROCESS (WITH ANNEALING)”, and “MOLDING, GATE CUTTING, INSPECTION, and PACKING”, or may be information identifying the procedure.

The input field F16 is a field in which injection molding device identification information for identifying the injection molding device desired by the user as the injection molding device for producing the target product is input. In FIG. 4, “DEVICE”, which is a character string superimposed on the input field F16, is a character string for indicating to the user that the information input to the input field F16 is the injection molding device identification information. In the example shown in FIG. 4, nothing is inputted in the input field F16. Here, the injection molding device identification information may be a name assigned to the injection molding device. Hereinafter, for convenience of description, the injection molding device identified by the injection molding device identification information input in the input field F16 will be referred to as a target injection molding device and the injection molding device identification information indicating the target injection molding device will be referred to as target injection molding device identification information and described.

The input field F17 is a field in which the metal mold identification information for identifying the metal mold to be attached to the target injection molding device is input. In FIG. 4, “METAL MOLD”, which is a character string superimposed on the input field F17, is a character string for indicating to the user that the information input to the input field F17 is the metal mold identification information. In the example shown in FIG. 4, nothing is inputted in the input field F17. Here, the metal mold identification information may be a name assigned to the metal mold. Hereinafter, for convenience of description, the metal mold identified by the metal mold identification information input to the input field F17 will be referred to as a target metal mold and the metal mold identification information for identifying the target metal mold will be referred to as target metal mold identification information and described. The input field F18 is a field in which number of cavities information indicating the number of cavities of the target metal mold is input. In FIG. 4, “NUMBER OF CAVITIES”, which is a character string superimposed on the input field F18, is a character string for indicating to the user that the information input to the input field F18 is the number of cavities information. In the example shown in FIG. 4, “0” is input to the input field F18 as the number of cavities information. This is because the initial value input to the input field F18 is “0”. Then, “O” as the number of cavities information indicates that the number of cavities indicated by the number of cavities information is zero. Hereinafter, for convenience of description, the number of cavities indicated by the number of cavities information input in the input field F18 will be referred to as a target number of cavities and the number of cavities information indicating the target number of cavities will be referred to as target number of cavities information and described.

The input field F19 is a field in which a character string input by the user is input as a comment. In the example shown in FIG. 4, “COMMENT” is input to the input field F19 as the character string.

The input field F20 is a field in which unit lot quantity information indicating a quantity per one lot of the production of the target product by the target injection molding device is input. In FIG. 4, “QUANTITY PER ONE LOT”, which is a character string superimposed on the input field F20, is a character string for indicating to the user that the information input to the input field F20 is the unit lot quantity information. In the example shown in FIG. 4, “0” is input to the input field F20 as the unit lot quantity information. This is because the initial value input to the input field F20 is “0”. Then, “O” as the unit lot quantity information indicates that the number of unit lot quantity information is zero. Hereinafter, for convenience of description, the number indicated by the unit lot quantity information input in the input field F20 will be referred to as a target unit lot quantity and the unit lot quantity information indicating the target unit lot quantity will be referred to as target unit lot quantity information and described.

The input field F21 is a field in which production planning start time information indicating a production planning start time for starting the production plan indicated by the production plan information generated in the production plan creation image P3 is input. In FIG. 4, “PLANNING START TIME”, which is a character string superimposed on the input field F21, is a character string for indicating to the user that the information input to the input field F21 is the production planning start time information. In the example shown in FIG. 4, nothing is inputted in the input field F21. Hereinafter, for convenience of description, the production planning start time indicated by the production planning start time information input to the input field F21 will be referred to as a target production planning start time and the production planning start time information indicating the target production planning start time will be referred to as target production planning start time information and described.

The input field F22 is a field in which the production quantity planned value information indicating the planned value of the production quantity of the target product by the target injection molding device is input. In FIG. 4, “PLANNING QUANTITY”, which is a character string superimposed on the input field F22, is a character string for indicating to the user that the information input to the input field F22 is the production quantity planned value information. In the example shown in FIG. 4, “0” is input to the input field F22 as the production quantity planned value information. This is because the initial value input to the input field F22 is “0”. Then, “0” as the production quantity planned value information indicates that the planned value indicated by the production quantity planned value information is zero. Hereinafter, for convenience of description, the planned value indicated by the production quantity planned value information input to the input field F22 will be referred to as a target production quantity planned value and the production quantity planned value information indicating the target production quantity planned value will be referred to as target production quantity planned value information and described.

The input field F23 is a field in which production planning start date and time information indicating the date and time obtained by combining the target production planning start date and the target production planning start time is input as the date and time for starting the production plan generated in the production plan creation image P3. In FIG. 4, “PLANNING START DATE AND TIME”, which is a character string superimposed on the input field F23, is a character string for indicating to the user that the information input to the input field F23 is the production planning start date and time information. In the example shown in FIG. 4, nothing is inputted in the input field F23.

The input field F24 is a field in which production planning completion date and time information indicating the planning completion date and time estimated for the completion of the production plan indicated by the production plan information generated in the production plan creation image P3 is input. In FIG. 4, “PLANNING COMPLETION DATE AND TIME”, which is a character string superimposed on the input field F24, is a character string for indicating to the user that the information input to the input field F24 is the production planning completion date and time information. In the example shown in FIG. 4, nothing is inputted in the input field F24.

The input field F25 is a field in which number of lots information indicating the number of lots of the target product to be produced according to the production plan indicated by the production plan information generated in the production plan creation image P3 is input. In FIG. 4, “NUMBER OF LOTS”, which is a character string superimposed on the input field F25, is a character string for indicating to the user that the information input to the input field F25 is the number of lots information. In the example shown in FIG. 4, “0” is input to the input field F25 as the number of lots information. This is because the initial value input to the input field F25 is “0”. Then, “O” as the number of lots information indicates that the number indicated by the number of lots information is zero.

The input field F26 is a field in which standard cycle time information indicating the standard cycle time of the target injection molding device to which the target metal mold is attached is input. In FIG. 4, “STANDARD CYCLE TIME”, which is a character string superimposed on the input field F26, is a character string for indicating to the user that the information input to the input field F26 is the standard cycle time information. In the example shown in FIG. 4, nothing is inputted in the input field F26.

The toggle switch TB is a toggle switch that receives an operation of selecting either an input quantity reference or a non-defective quantity reference as a condition for completing the production plan indicated by the production plan information generated in the production plan creation image P3. When the server 30 receives the operation of selecting the input quantity reference via the toggle switch TB, it changes the display mode of the toggle switch TB to a display mode indicating that the input quantity reference is selected. On the other hand, when the server 30 the receives operation of selecting the non-defective quantity reference via the toggle switch TB, it changes the display mode of the toggle switch TB to a display mode indicating that the non-defective quantity reference is selected. These display mode of the toggle switch TB may be any mode as long as it is a display mode that is possible to distinguish whether the condition selected by the toggle switch TB is the input quantity reference or the non-defective quantity reference. Here, the input quantity reference is that the total number of target products produced according to the production plan reaches the target production quantity planned value. On the other hand, the non-defective quantity reference is that the number obtained by subtracting the number of defective products from the total number of target products produced according to the production plan reaches the target production quantity planned value. The toggle switch TB shown in FIG. 4, the condition selected by the toggle switch TB indicates the input quantity reference.

The button B31 is a button for receiving an operation to execute a plan allocation process. The plan allocation process will be described later.

The button B32 is a button for receiving an operation to execute the hourly production quantity designation process. The hourly production quantity designation process will be described later.

The graph GP is a graph in which the above described plot of the histogram and the display of the inoperable time period are performed as an example of the production plan information created in the production plan creation image P3 when operation of the button B31 or button B32 is performed. In the example shown in FIG. 4, nothing is plotted in the graph GP. That is, in the present example, the production plan information has not yet been generated in the production plan creation image P3.

Such a production plan creation image P3 performs operations as described below.

When generating the production plan creation image P3, the server 30 identifies the user identification information and the user name information of the user who is logging in the server 30. The method of identifying the user identification information and the user name information by the server 30 may be a known method or a method to be developed. In the present case, the server 30 identifies the current date. The method of identifying the current date by the server 30 may be a known method or a method to be developed. After identifying the user identification information, the user name information, and the current date, server 30 generates a production plan creation image P3 in which the identified user identification information is input to the input field F11, the identified user name information is input to the input field F12, and the production planning start date information indicating the identified current date is input to the input field F13. The server 30 causes the terminal device 40 to display the generated production plan creation image P3. Therefore, the production plan creation image P3 shown in FIG. 4 is the production plan creation image P3 in the initial state displayed on the terminal device 40.

Here, the server 30 may be configured to receive direct input by an input device such as a keyboard in the input field F13. In this case, the server 30 inputs the date input by the input device to the input field F13 as the production planning start date information. The server 30 may be configured to display a calendar image indicating a calendar by receiving a selection operation at a predetermined mark associated with the input field F13. In this case, the server 30 may be configured to receive a selection operation of a year, month, and day on the calendar image, thereby inputting information indicating the year, month, and day on which the selection operation was received into the input field F13 as production planning start date information.

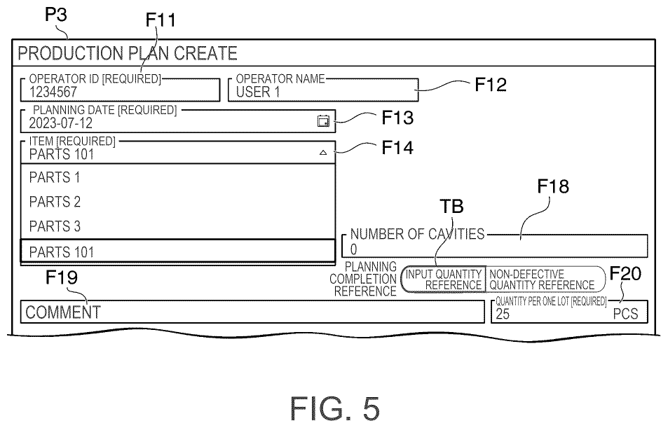

When a selection operation at the input field F14 is performed, the server 30 refers to the master data stored in advance and causes it to display a pull-down menu including a list of one or more product type information included in the master data on the production plan creation image P3. In the present embodiment, the selection operation is a click, a tap, or the like, but is not limited thereto. FIG. 5 is a diagram showing an example of a state in which the pull-down menu is displayed in the input field F14. In the example shown in FIG. 5, four pieces of product type information of “PARTS 1”, “PARTS 2”, “PARTS 3”, and “PARTS 101” are displayed in the pull-down menu of the input field F14, and “PARTS 101” is selected from these four pieces of product type information. Therefore, “PARTS 101” is input to the input field F14 as the product type information. In this case, the server 30 refers to the master data and inputs the unit lot quantity information associated with “PARTS 101” to the input field F20. That is, when the product type information is input to the input field F14, the server 30 inputs the unit lot quantity information associated with the product type information input to the input field F14 and inputs the extracted unit lot quantity information to the input field F20. In the example shown in FIG. 5, “25” is input to the input field F20 as the unit lot quantity information. That is, in the present example, the unit lot quantity information associated with “PARTS 101” is “25”. This indicates that the target unit lot quantity is 25 pieces. Note that in FIG. 5, each of the input field F15 to the input field F17 is hidden behind the pull-down menu of the input field F14 and is not visible.

When a selection operation at the input field F15 is performed, the server 30 refers to the master data stored in advance and causes it to display a pull-down menu including a list of one or more procedure information included in the master data on the production plan creation image P3. The pull-down menu is the same GUI as the pull-down menu of the input field F14. Therefore, the pull-down menu of the input field F15 will not be described with reference to the drawings. When the server 30 receives the operation of selecting certain procedure information from the pull-down menu of the input field F15, it causes it to display the procedure information in the input field F15. Note that the server 30 may be configured to receive direct input from the input device such as the keyboard in the input field F15. In this case, the server 30 inputs the character string input by the input device to the input field F15 as the procedure information. The server 30 may be configured to, when the product type information is input to the input field F14, input the procedure information associated with the product type information in the master data to the input field F15. In this case, in the master data, the procedure information is associated with each product type information.

When a selection operation at the input field F16 is performed, the server 30 refers to the master data stored in advance and causes it to display a pull-down menu including a list of one or more injection molding device identification information included in the master data on the production plan creation image P3. The pull-down menu is the same GUI as the pull-down menu of the input field F14. Therefore, the pull-down menu of the input field F16 will not be described with reference to the drawings. When the server 30 receives the operation of selecting certain injection molding device identification information from the pull-down menu of the input field F16, it inputs the injection molding device identification information to the input field F16. Note that the server 30 may be configured to receive direct input from the input device such as the keyboard in the input field F16. In this case, the server 30 inputs the character string input by the input device to the input field F16 as the injection molding device identification information. The server 30 may be configured to, when the product type information is input to the input field F14, input the injection molding device identification information associated with the product type information in the master data to the input field F16. In this case, in the master data, the injection molding device identification information is associated with each product type information.

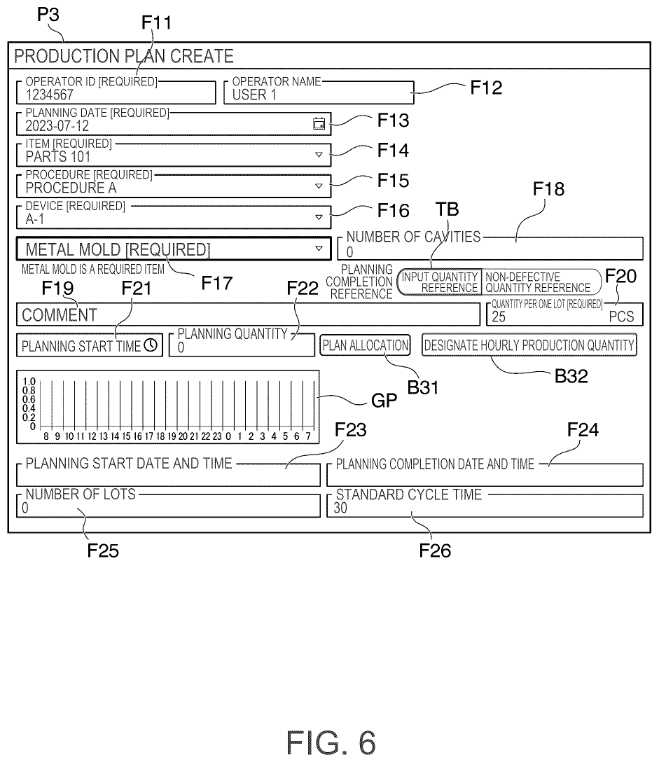

Here, when the injection molding device identification information is input to the input field F16, the server 30 refers to the master data and inputs the standard cycle time information associated with the injection molding device identification information to the input field F26. That is, when the injection molding device identification information is input to the input field F16, the server 30 inputs the standard cycle time information associated with the injection molding device identification information input to the input field F16 from the master data, and inputs the extracted standard cycle time information to the input field F26. FIG. 6 is a diagram showing an example of a state in which the injection molding device identification information is input to the input field F16 and thus the standard cycle time information is input to the input field F26. In the example shown in FIG. 6, “A-1” is input to the input field F16 as the injection molding device identification information. In the present example, “30” is input to the input field F26 as the standard cycle time information. That is, in the master data in the present example, the target standard cycle time information “30” is associated with the target injection molding device identification information “A-1”. “30” indicates that the standard cycle time indicated by the standard cycle time information input to the input field F26 is 30 seconds. Note that when the server 30 may be configured to, when the product type information is input to the input field F14, input the standard cycle time information associated with the product type information in the master data to the input field F26. In this case, in the master data, the standard cycle time information is associated with each product type information.

When a selection operation at the input field F17 is performed, the server 30 refers to the master data stored in advance and causes it to display a pull-down menu including a list of one or more metal mold identification information included in the master data on the production plan creation image P3. The pull-down menu is the same GUI as the pull-down menu of the input field F14. Therefore, the pull-down menu of the input field F17 will not be described with reference to the drawings. When the server 30 receives the operation of selecting certain metal mold identification information from the pull-down menu of the input field F17, it inputs the metal mold identification information to the input field F17. Note that the server 30 may be configured to receive direct input from the input device such as the keyboard in the input field F17. In this case, the server 30 inputs the character string input by the input device to the input field F17 as the metal mold identification information. The server 30 may be configured to, when the product type information is input to the input field F14, input the metal mold identification information associated with the product type information in the master data to the input field F17. In this case, in the master data, the metal mold identification information is associated with each product type information.

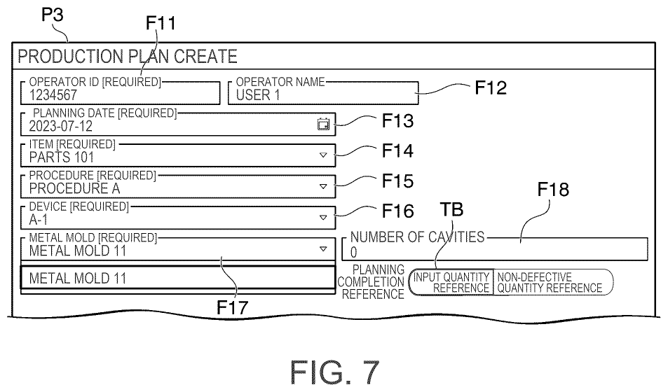

Here, when the metal mold identification information is input to the input field F17, the server 30 refers to the master data and inputs the number of cavities information associated with the metal mold identification information to the input field F18. That is, when the metal mold identification information is input to the input field F17, the server 30 extracts the number of cavities information associated with the metal mold identification information input to the input field F17 from the master data and inputs the extracted number of cavities information to the input field F18. FIG. 7 is a diagram showing an example of a state in which the metal mold identification information is input to the input field F17 and thus the number of cavities information is input to the input field F18. In the example shown in FIG. 7, “METAL MOLD 11” is input to the input field F17 as the metal mold identification information. In the present example, “4” is input to the input field F18 as the number of cavities information. That is, in the master data in the present example, the metal mold identification information “METAL MOLD 11” is associated with the number of cavities information “4”. In this case, the number of molded articles that can be molded in one shot using the metal mold identified by “METAL MOLD 11” is 4 pieces.

Note that as shown in FIG. 4, a character string “[REQUIRED]” is superimposed on each of the input field F14 to the input field F17. This indicates that the input to each of the input field F14 to the input field F17 is “REQUIRED” in the generation of the production plan information via the production plan creation image P3. For this reason, in the production plan creation image P3, when the production plan information is to be generated in a state where the input to the input field described as “[REQUIRED]” is not completed, the server 30 changes the display mode of the input field to a display mode indicating that the input is not completed, as in the character string “[REQUIRED]” of the input field F17 shown in FIG. 6. Such a change in the display mode may be, for example, a change in the color of the character string “[REQUIRED]” or a change in another display mode. In the example shown in FIG. 6, the character string “[REQUIRED]” in the input field F17 is changed to a color different from the color of the character string “[REQUIRED]” in each of the input field F14 to the input field F16. By this, the server 30 can prevent the user from forgetting to input information that needs to be input in the generation of the production plan information. Note that such a change in the display mode may be performed, for example, when information input in an input field in which “[REQUIRED]” is described is deleted.

The server 30 receives direct input from the input device such as the keyboard in the input field F19. Specifically, the server 30 inputs the character string input by the input device to the input field F19 as a comment.

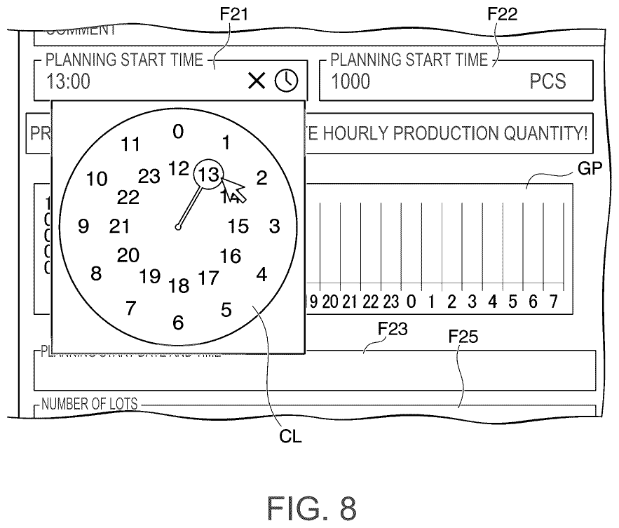

When a selection operation at the input field F21 is performed, the server 30 causes the terminal device 40 to display a production planning start time reception image CL that receives the production planning start time. The production planning start time reception image CL is an image showing, for example, a dial of a clock. FIG. 8 is a diagram showing an example of the production planning start time reception image CL displayed on the production plan creation image P3. In the example shown in FIG. 8, the clock face indicated by the production planning start time reception image CL is the dial of a circular analog clock. On the outermost periphery of the dial indicated by the production planning start time reception image CL, numerals from 0 to 11 are arranged clockwise in order at equal intervals like a clock. On the inner side of the outermost periphery of the dial indicated by the production planning start time reception image CL, numerals from 12 to 23 are arranged clockwise in order at equal intervals like a clock. When the server 30 receives the operation of selecting one of the 24 numbers 0 to 23, it receives the time selected by the received operation as the production planning start time. Then, the server 30 inputs the production planning start time information indicating the received production planning start time to the input field F21. In the example shown in FIG. 8, “13” is selected among the 24 numerals. For this reason, “13:00” is input to the input field F21 as the production planning start time information. In the present example, “13:00” in the input field F21 indicates that the production planning start time is 13 o'clock. Here, in FIG. 8, the numeral that is selected among the 24 numerals is indicated by a circle positioned at the tip end of a straight line extending from the center of the dial indicated by the production planning start time reception image CL to the outer periphery. The user can select, by moving the position of this circle, a time on the production planning start time reception image CL. That is, the display state of the production planning start time reception image CL changes in accordance with the received operation and the time associated with each display state of the production planning start time reception image CL is received as the production planning start time. In the example shown in FIG. 8, the user can select the production planning start time only in units of one hour on the production planning start time reception image CL However, the server 30 may be configured to, when the selection operation at the input field F21 is performed, display the production planning start time reception image CL that can select the production planning start time in units of one minute or it may be configured to display the production planning start time reception image CL that can select the production planning start time in other time units. The server 30 may be configured to receive direct input from the input device such as the keyboard in the input field F21. In this case, the server 30 inputs the information indicating the planning start time input by the input device to the input field F21 as the production planning start time information.

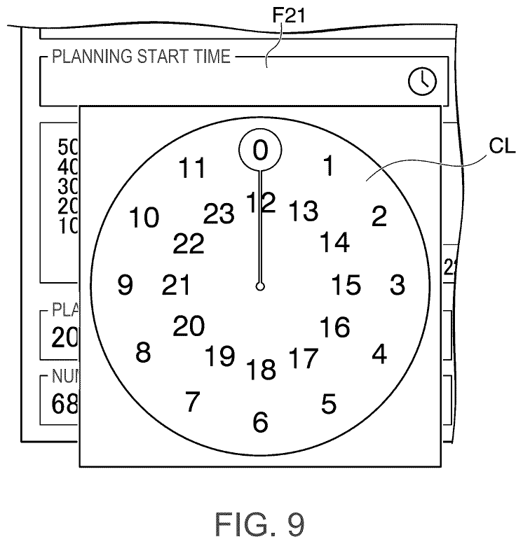

Note that the production planning start time selected in the initial state of the production planning start time reception image CL may be 0 o'clock or another time. FIG. 9 is a diagram showing an example of the production planning start time reception image CL in the initial state. In the example shown in FIG. 9, the production planning start time selected in the initial state of the production planning start time reception image CL is 0 o'clock.

The server 30 receives direct input from the input device such as the keyboard in the input field F22. Specifically, the server 30 inputs the information indicating the numerical value input by the input device to the input field F22 as the production quantity planned value information. For example, in the example shown in FIG. 8, “1000” is input to the input field F22 as the production quantity planned value information. This indicates that the planned value indicated by the production quantity planned value information input in the input field F22 is 1000 pieces.

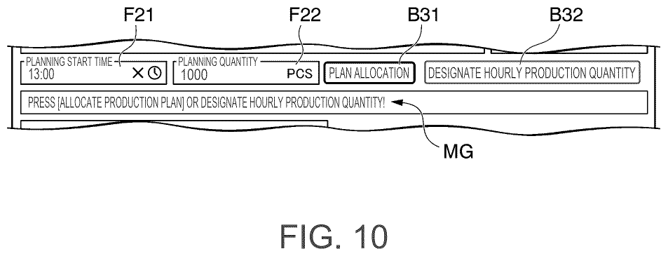

When all the information in the input field F13 to the input field F22 is input, the server 30 displays a message indicating the next operation to be performed by the user on the production plan creation image P3. FIG. 10 is a diagram showing an example of when all the information of the input field F13 to the input field F22 is input, the message displayed on the production plan creation image P3. The message shown in FIG. 10 is “PRESS [ALLOCATE PRODUCTION PLAN] OR DESIGNATE HOURLY PRODUCTION QUANTITY!”. In the present case, this means that the operation to be performed next by the user is a selection operation at either the button B31 or the button B32. Note that the server 30 may be configured not to display such a message in such a case.

When the selection operation at the button B31 is performed, the server 30 performs the above described plan allocation process. The plan allocation process is a process in which the server 30 generates the production plan information based on all the information from input field F13 to the input field F22 and the input field F26. Here, each of the input field F23 to the input field F25 and the graph GP are a GUI on which information relating to the production plan indicated by the production plan information generated on the production plan creation image P3 is displayed. That is, in the present case, the server 30 generates the production plan information based on all of the information, and performs a process of displaying the information relating to the production plan indicated by the generated production plan information in each of the input field F23 to the input field F25 and the graph GP as the plan allocation process. The information input to each of the input field F13 to the input field F22 and the input field F26 is an example of production plan related information relating to the production plan indicated by the production plan information generated in the production plan creation image P3. That is, in the present case, the server 30 generates the production plan information based on the production plan related information.

More specifically, the server 30 performs a process as described below as the plan allocation process. Note that in the following, as an example, a case where one day is divided into 24 time periods a time period of 0 o'clock to 1 o'clock, a time period of 1 o'clock to 2 o'clock, - - - , and a time period of 23 o'clock to 24 o'clock will be described. Hereinafter, for convenience of description, the time period from the time N o'clock to the time N+1 o'clock will be referred to as the N-th time period and described. Hereinafter, for convenience of description, these 24 time periods will be simply referred to as 24 time periods. Note that in the plan allocation process, the server 30 may be configured to handle one day by dividing the day into more than 24 time periods.

When the selection operation at the button B31 is performed, the server 30 identifies the target production planning start time. The server 30 determines, from the 24 time periods, one or more time periods including a time between the identified target production planning start time and a time after a predetermined preparation time elapses from the target production planning start time as the preparation time period. The preparation time period is a time period in which preparation for operating the target injection molding device to produce the target product is performed. The preparation includes attachment of the target metal mold to the target injection molding device, replenishment of the molding material used by the target injection molding device, and the like, but is not limited thereto. Note that the preparation time may be a time of 1 hour or less and may be a time of more than 1 hour. Hereinafter, as an example, a case where the preparation time is 1 hour will be described. In the examples shown in FIG. 4 to FIG. 10, the target production planning start time was 13 o'clock. In this case, the preparation time period is the 13th time period.

After determining the preparation time period, the server 30 identifies the operating time period in which the target injection molding device is operated to produce the target product as the first operating time period. For example, in order to identify the first operating time period, the server 30 calculates the planned value of the production quantity of the target product per unit time by the target injection molding device to which the target metal mold is attached. Hereinafter, as an example, a case where the unit time is 1 hour will be described. Note that the unit time may be any other time as long as it is the time designated as the unit time by the user. The server 30 calculates the planned value using, for example, the following expression (1). Hereinafter, for convenience of equation, the planned value will be simply referred to as a unit time planning value and described.

(unit time planning value)=((unit time)/(target standard cycle time))×(number of cavities) (1)

In the example shown in FIG. 4 to FIG. 10, the target standard cycle time was 30 seconds. In the present example, the number of cavities was 4 pieces. Therefore, the unit time planning value calculated from above expression (1) is (3600 seconds/30 seconds)×4 pieces=480 pieces. Therefore, in the present example, the unit time planning value of the target injection molding device to which the target metal mold is attached is 480 pieces.

After the unit time planning value is calculated in this manner, when the target product of the target production quantity planned value is produced, the server 30 calculates the production quantity of the target product scheduled to be produced every hour from the end time of the identified preparation time period as a unit time production quantity. Here, in the example shown in FIG. 4 to FIG. 10, the target production quantity planned value was 1000 pieces. As described above, the unit time planning value in the present example is 480 pieces. For this reason, the unit time production quantity between 14 o'clock and 15 o'clock, which is the time in the present example, is 480 pieces. The unit time production quantity between 15 o'clock and 16 o'clock is 480 pieces. The unit time production quantity between 16 o'clock and 17 o'clock is 40 pieces. By this, the target injection molding device to which the target metal mold is attached can produce 1000 pieces of target products, which is the target production quantity planned value, between 14 o'clock and 17 o'clock, which is the end time of the 13th time period, which is the preparation time period. The server 30 identifies a time period from the next time period of the preparation time period to a time period in which the unit time production quantity does not satisfy the unit time planning value as the first operating time period. In this example, the first operating time period is a time period from 14 o'clock to 17:00 o'clock. In this case, the first operating time period includes the three time periods of the 14th time period, the 15th time period, and the 16th time period.

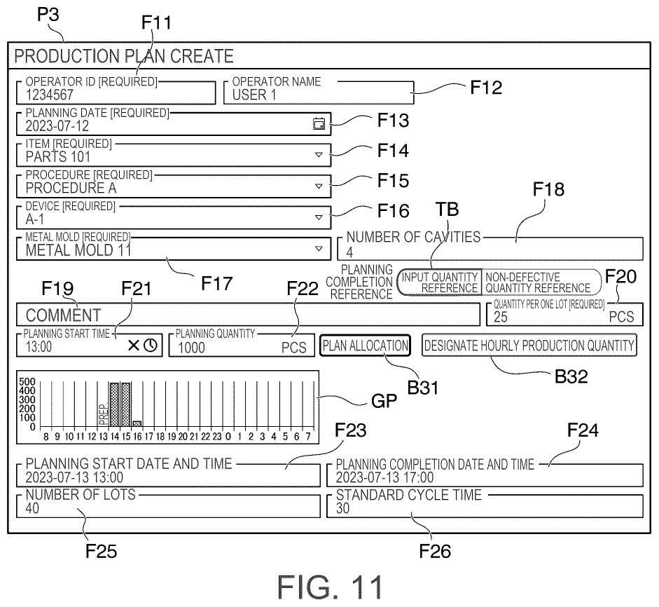

After calculating the unit time production quantity in each time period included in the first operating time period, the server 30 plots the calculated unit time production quantity for each time period on the graph GP. FIG. 11 is a diagram showing an example of the production plan creation image P3 after the selection operation at the button B31 and the plotting to the graph GP are performed. Here, the graph GP is a graph in which a histogram showing the unit time production quantity in each of 24 time periods is plotted. On a horizontal axis of the graph GP, each of the 24 time periods is shown in time order. A vertical axis of the graph GP indicates the unit time production quantity. In the example shown in FIG. 11, the histogram of the 14th time period of the graph GP shows 480 pieces as the unit time production quantity of the 14th time period. In the present example, the histogram of the 15th time period of the graph GP shows 480 pieces as the unit time production quantity of the 15th time period. In the present example, the histogram of the 16th time period of the graph GP shows 40 pieces as the unit time production quantity of the 16th time period. In this manner, the server 30 plots the calculated unit time production quantity for each time period on the graph GP. Therefore, the user can visually check the time period in which the histogram is plotted on the graph GP as the first operating time period. That is, the histogram plotted in this manner is an example of the first operating time period information indicating the first operating time period.

When the histogram is plotted on the graph GP, the server 30 displays preparation time period information indicating the identified preparation time period on the graph GP. In the example shown in FIG. 11, the character string of “PREP.” indicating that the 13th time period is the preparation time period is displayed on graph GP. That is, in the present example, the character string of “PREP.” is an example of the preparation time period information indicating the preparation time period. In other words, in the present example, the character string of “PREP.” is an example of the above described inoperable time period information.

The server 30 performs such a plot of the histogram on the graph GP and performs input information to each of the input field F23, the input field F24, and the input field F25. Specifically, the server 30 inputs information indicating the production planning start date and time, which is a combination of the target production planning start date and the target production planning start time, to the input field F23 as the production planning start date and time information. Therefore, in the example shown in FIG. 11, “2023 Jul. 13 13:00” is input to the input field F23. This indicates that the production planning start date and time is 13 o'clock on Jul. 13, 2023. The server 30 inputs information indicating the product planning completion date and time, which is a combination of the target production planning start date and time and the end time of the first operating time period, to the input field F24 as the production planning completion date and time information. Therefore, in the present example, “2023 Jul. 13 17:00” is input to the input field F24. This indicates that the product planning completion date and time is 17 o'clock on Jul. 13, 2023. The server 30 inputs information indicating a value obtained by dividing the target production quantity planned value by the target unit lot quantity to the input field F25 as the number of lots information. In the present example, “40” is input to the input field F25. This indicates that the target number of lots indicated by the target number of lots information is 40 pieces.

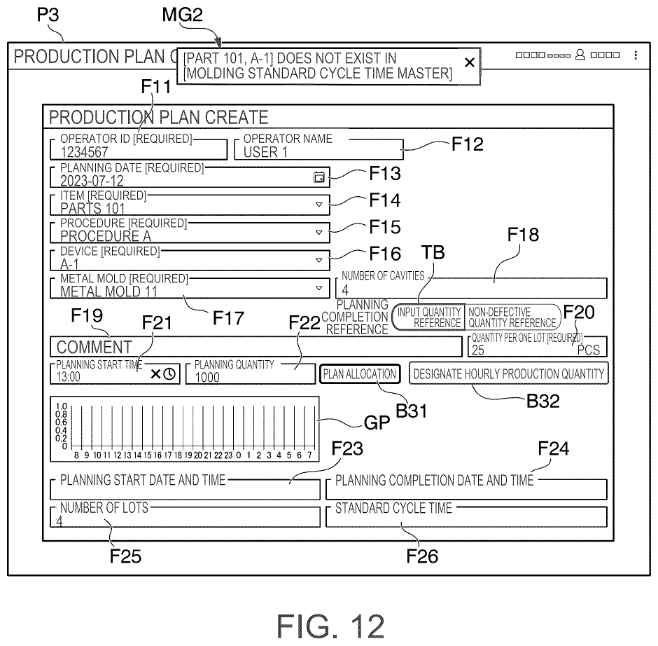

The server 30 performs the above process as the plan allocation process. Note that when the server 30 receives the selection operation at button B31 when the input of information into at least one of input field F13 to input field F22 and input field F26 is not complete, it displays an error message MG2 on the production plan creation image P3 as shown in FIG. 12. FIG. 12 is a diagram showing an example of the production plan creation image P3 when the error message MG2 is displayed. In the example shown in FIG. 12, the error message MG2 is “[PART 101, A-1] DOES NOT EXIST IN [MOLDING STANDARD CYCLE TIME MASTER]”. In this case, the error message MG2 is an error message displayed by the server 30 because the standard cycle time information is not associated in the master data with the injection molding device identification information for identifying the target injection molding device and, although the server 30 was not able to input the standard cycle time information to the input field F26, the server 30 received the selection operation at the button B31.

The server 30 may display such an error message when the combination of the information input to each of the input field F13 to the input field F22 and the input field F26 is not a correct combination. For example, the server 30 may be configured to display the error message on the production plan creation image P3 when the target metal mold is a metal mold that cannot be attached to the target injection molding device, when the target product is a product that cannot be produced by the target metal mold, or the like. The server 30 can determine, for example, based on the master data, that the target metal mold is a metal mold that cannot be attached to the target injection molding device, that the target product is a product that cannot be produced by the target metal mold, or the like. Such a determination method based on the master data may be a known method or a method to be developed.

When the selection operation at the button B32 is performed, the server 30 performs the above described hourly production quantity designation process. The hourly production quantity designation process is a process of receiving an operation of designating each of the first operating time period, the unit time production quantity in each time period included in the first operating time period, and the inoperable time period such as the preparation time period from the user. In the hourly production quantity designation process, the reception image P4 for receiving operations is displayed and the plotting of the histogram in the graph GP and the input of information to each of the input field F23 to the input field F25 are performed by the server 30 according to the operation received by the server 30 via the displayed reception image P4. In this case, all the information of the input field F13 to the input field F22 and the input field F26 and the information received via the reception image P4 are examples of the production plan related information described above. That is, even in the present case, the server 30 causes the terminal device 40 to display the production plan information based on the production plan related information.

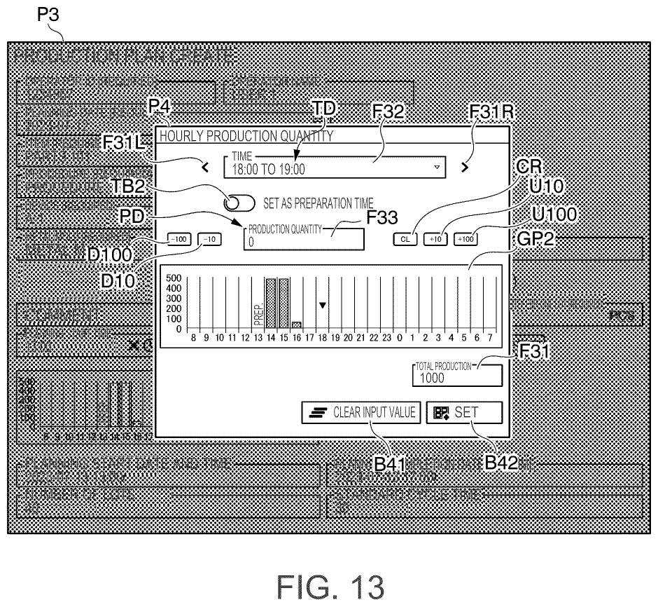

More specifically, the server 30 performs a process described below as the hourly production quantity designation process. When the selection operation at the button B32 is performed, the server 30 displays the reception image P4 as shown in FIG. 13 on the production plan creation image P3. FIG. 13 is a diagram showing an example of the reception image P4 displayed on the production plan creation image P3.

In the example shown in FIG. 13, the reception image P4 includes a time period designation section TD, a toggle switch TB2, a production quantity designation section PD, the graph GP2, an input field F31, a button B41, and a button B42. Note that the reception image P4 may include another GUI in addition to the time period designation section TD, the toggle switch TB2, the production quantity designation section PD, the graph GP2, the input field F31, the button B41, and the button B42.

The time period designation section TD includes an input field F32, a time period change button F31L, and a time period change button F31R.

The input field F32 is a field in which the designated time period information indicating the time period to be designated in the first operating time period, the inoperable time period, or the like is input. When displaying the reception image P4, the server 30 generates the reception image P4 in which the designated time period information determined in advance as the designated time period information to be input to the input field F32 in the initial state of the reception image P4 is input to the input field F32 and displays the generated reception image P4 on the production plan creation image P3. The predetermined designated time period information is, for example, the designated time period information indicating the 0th time period, but is not limited thereto. In the example shown in FIG. 13, the designated time period information indicating the 18th time period is input to the input field F32. Hereinafter, for convenience of description, the designated time period information input in the input field F32 will be referred to as target designated time period information and the designated time period indicated by the target designated time period information will be referred to as the target designated time period and described.

The time period change button F31L is a button for changing the current target designated time period information to the designated time period information indicating a time period immediately before the current target designated time period. When the server 30 receives a selection operation at the time period change button F31L, it changes the current target designated time period information to the designated time period information indicating a time period immediately before the current target designated time period. For example, when the server 30 receives the selection operation at the time period change button F31L in the reception image P4 shown in FIG. 13, it changes the current target designated time period information to the designated time period information indicating the 17th time period, which is one time period immediately before the 18th time period indicated by the current target designated time period information.

The time period change button F31R is a button for changing the current target designated time period information to the designated time period information indicating a time period immediately after the current target designated time period. When the server 30 receives the selection operation for the time period change button F31R, it changes the current target designated time period information to the designated time period information indicating a time period immediately after the current target designated time period. For example, when the server 30 receives the selection operation at the time period change button F31R in the reception image P4 shown in FIG. 13, it changes the current target designated time period information to the designated time period information indicating the 19th time period, which is one time period immediately after the 18th time period indicated by the current target designated time period information.

Note that the server 30 may be configured to receive direct input from the input device such as the keyboard in the input field F32. In this case, the server 30 inputs the designated time period information input by the input device to the input field F32.

Since the time period designation section TD has the time period change button F31L and the time period change button F31R in this manner, the user can designate the designated time period without operating the keyboard in the reception image P4. This is useful when the terminal device 40 is not provided with a keyboard as in a smartphone.

The toggle switch TB2 is a toggle switch that receives an operation of selecting whether or not to designate the target designated time period as the preparation time period. When the server 30 receives the operation of selecting designation of the target designated time period as the preparation time period via the toggle switch TB2, it changes the display mode of the toggle switch TB2 to a display mode indicating that designation of the target designated time period as the preparation time period is selected. On the other hand, when the server 30 receives the operation of selecting not to designate the target designated time period as the preparation time period via the toggle switch TB2, it changes the display mode form of the toggle switch TB2 to a display mode form indicating that it is selected not to designate the target designated time period as the preparation time period. These display modes of the toggle switch TB2 may be any mode as long as it is a display mode that is possible to distinguish whether the condition selected by the toggle switch TB2 is to designate the target designated time period as the preparation time period or not. Here, the toggle switch TB2 shown in FIG. 13 indicates that the toggle switch TB2 has selected not to designate the target designated time period as the preparation time period.

The production quantity designation section PD has the input field F33, a production quantity change button D10, a production quantity change button D100, a production quantity change button U10, a production quantity change button U100, and a production quantity reset button CR.

The input field F33 is a field in which unit time production quantity information indicating the unit time production quantity of the target designated time period is input. When displaying the reception image P4, the server 30 generates the reception image P4 in which the unit time production quantity information determined in advance as the unit time production quantity information input to the input field F33 in the initial state of the reception image P4 is input to the input field F33 and displays the generated reception image P4 on the production plan creation image P3. The predetermined unit time production quantity information is, for example, the unit time production quantity information indicating 0 pieces, but is not limited thereto. In the example shown in FIG. 13, the unit time production quantity information indicating 0 is input to the input field F33. Hereinafter, for convenience of description, the unit time production quantity information input in the input field F33 will be referred to as target unit time production quantity information and the unit time production quantity indicated by the target unit time production quantity information will be referred to as target unit time production quantity and described.

The production quantity change button D10 is a button for receiving an operation of changing the current target unit time production quantity information to the unit time production quantity information indicating the unit time production quantity after subtracting a predetermined first subtraction value from the current target unit time production quantity. In the example shown in FIG. 13, the first subtraction value is 10. Note that the first subtraction value may be any value instead of 10 as long as it is an integer of 1 or more and smaller than a second subtraction value (to be described later). When the server 30 receives the selection operation at the production quantity change button D10, it changes the current target unit time production quantity information to the unit time production quantity information indicating the unit time production quantity after subtracting the first subtraction value determined in advance from the current target unit time production quantity.

The production quantity change button D100 is a button for receiving an operation of changing the current target unit time production quantity information to the unit time production quantity information indicating the unit time production quantity after subtracting a predetermined second subtraction value from the current target unit time production quantity. In the example shown in FIG. 13, the second subtraction value is 100. Note that the first subtraction value may be any value instead of 100 as long as it is an integer larger than the first subtraction value. When the server 30 receives the selection operation at the production quantity change button D100, it changes the current target unit time production quantity information to the unit time production quantity information indicating the unit time production quantity after subtracting the second subtraction value determined in advance from the current target unit time production quantity.

The production quantity change button U10 is a button for receiving an operation of changing the current target unit time production quantity information to the unit time production quantity information indicating the unit time production quantity after adding a predetermined first addition value to the current target unit time production quantity. In the example shown in FIG. 13, the first addition value is 10. Note that the first addition value may be any value instead of 10 as long as it is an integer of 1 or more smaller than a second addition value (to be described later). When the server 30 receives the selection operation at the production quantity change button U10, it changes the current target unit time production quantity information to the unit time production quantity information indicating the unit time production quantity after adding the predetermined first addition value to the current target unit time production quantity.

The production quantity change button U100 is a button for receiving an operation of changing the current target unit time production quantity information to the unit time production quantity information indicating the unit time production quantity after adding a predetermined second addition value to the current target unit time production quantity. In the example shown in FIG. 13, the second addition value is 100. Note that the second addition value may be any value instead of 100 as long as it is an integer larger than the first addition value. When the server 30 receives the selection operation at the production quantity change button U100, it changes the current target unit time production quantity information to the unit time production quantity information indicating the unit time production quantity after adding the predetermined second addition value to the current target unit time production quantity.

The production quantity reset button CR is a button for receiving an operation of resetting the current target unit time production quantity information to the unit time production quantity information indicating 0 pieces. When the server 30 receives the selection operation at the production quantity reset button CR, it resets the current target unit time production quantity information to the unit time production quantity information indicating 0 pieces. Note that such resetting of the target unit time production quantity information may be reset to the unit time production quantity information indicating 1 piece or more pieces, instead of resetting to the unit time production quantity information indicating 0 pieces.

Note that since the production quantity designation section PD has the production quantity change button D10, the production quantity change button D100, the production quantity change button U10, the production quantity change button U100, and the production quantity reset button CR in this manner, the user can designate the unit time production quantity without operating the keyboard in the reception image P4. This is useful when the terminal device 40 is not provided with a keyboard as in a smartphone.

The graph GP2 is the same graph as the graph GP. That is, on the horizontal axis of the graph GP2, each of the 24 time periods is shown in time order. The vertical axis of graph GP2 indicates the planned value. When displaying the reception image P4, the server 30 identifies the state of the graph GP at the timing of displaying the reception image P4, generates the graph GP in the same state as the identified state, generates the reception image P4 including the generated graph GP, and displays the generated reception image P4 on the production plan creation image P3. Here, the state of the graph GP is distinguished by the histogram plotted on the graph GP and the inoperable time period information displayed on the graph GP. Therefore, when the selection operation at the button B32 is performed after the selection operation at the button B31 is performed, the same graph as the graph GP after the plotting of the histogram and the display of the inoperable time period information are performed by the plan allocation process is displayed as the graph GP2 on the reception image P4. On the other hand, when the selection operation at the button B32 is performed without performing the selection operation at the button B31, the graph GP2 in which the histogram is not plotted and the inoperable time period information is not displayed is displayed on the reception image P4. Hereinafter, for convenience of description, among the states of the graph GP2, a state in which the histogram is not plotted and the inoperable time period information is not displayed will be referred to as an initial state of the graph GP2 and described.

When one or more histograms are plotted on the graph GP2, the input field F31 is a field in which information indicating the total of the unit time production quantity indicated by each of one or more histograms is displayed as the production quantity planned value information. When no histogram is plotted on graph GP2, the production quantity planned value information indicating 0 pieces is input into input field F31. In the example shown in FIG. 13, the total is 1000 pieces. Therefore, in the present example, “1000” is input to the input field F31. This indicates that the total is 1000 pieces.

The button B41 is a button for receiving an operation of resetting the state of the graph GP2 to the initial state of the graph GP2. When the server 30 receives the selection operation at the button B41, it resets the state of the graph GP2 to the initial state of the graph GP2.

The button B42 is a button for receiving an operation of determining the production plan of the target product based on the information received via the reception image P4. When the server 30 receives the selection operation at the button B42, it performs the following process. That is, in the present case, the server 30 matches the state of the graph GP with the state of the graph GP2 and inputs the production quantity planned value information input in the input field F31 into the input field F22. In the present case, the server 30 inputs information indicating a date and time obtained by combining the target production planning start date and the target production planning start time into the input field F23 as the production planning start date and time information. In the present case, the server 30 inputs information indicating the date and time obtained by combining the target production planning start date and time and the end time of the first operating time period in the graph GP2 to the input field F24 as the production planning completion date and time information. In the present case, the server 30 inputs information indicating a value obtained by dividing the value indicated by the production quantity planned value information input to the input field F31 by the target unit lot quantity into the input field F25 as the number of lots information. In the present case, the server 30 performs the process as described above.

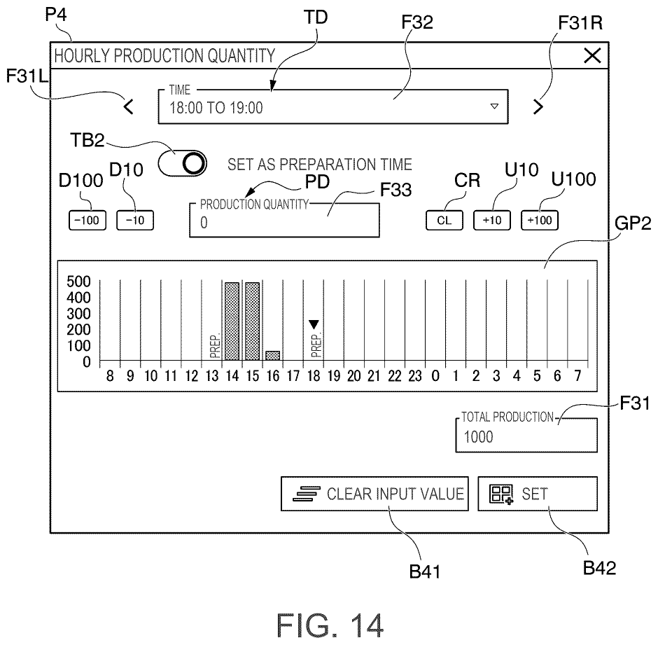

Here, a method of using the reception image P4 by the user will be described. In the time period designation section TD, the user inputs the designated time period information indicating a desired designated time period into the input field F32. For example, when the target designated time period indicated by the target designated time period information is desired to be designated as the preparation time period, the user inputs the designated time period information to the input field F32 and then selects to designate the target designated time period as the preparation time period by the selection operation at the toggle switch TB2. FIG. 14 is a diagram showing an example of the reception image P4 immediately after the target designated time period is designated as the preparation time period. In the example shown in FIG. 14, the target designated time period is the 18th time period. In the present example, the toggle switch TB2 indicates that it is selected to designate the target designated time period as the preparation time period. When the selection operation is performed at the toggle switch TB2 in this manner, the server 30 causes it to display the preparation time period information indicating that the 18th time period, which is the target designated time period, is the preparation time period on the graph GP2. In FIG. 14, the character string of “PREP.” indicating that the 18th time period is the preparation time period is displayed on the graph GP2. This is a character string that is not displayed in the reception image P4 shown in FIG. 13. In this manner, the server 30 can cause it to display the preparation time period information on the graph GP2 according to the operation received via the reception image P4.

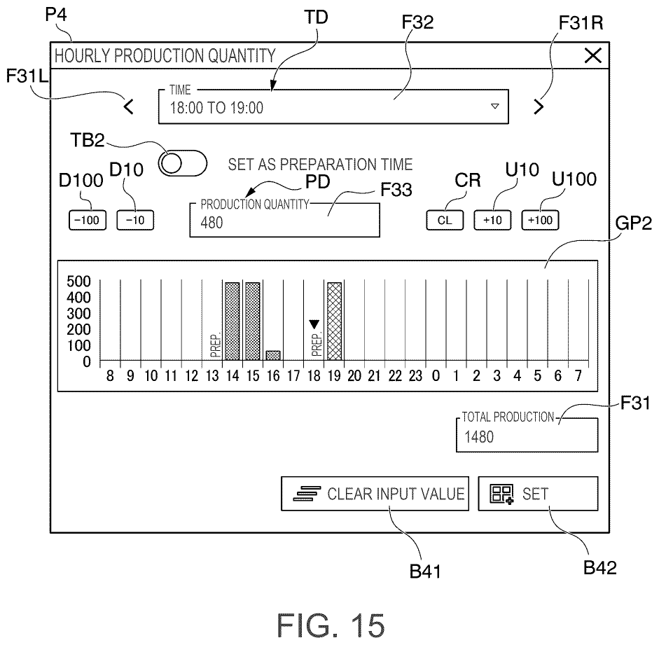

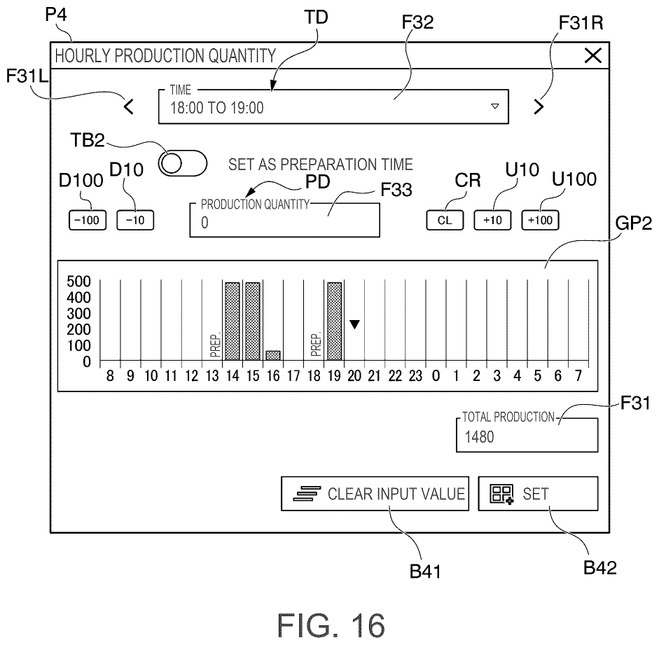

On the other hand, in the production quantity designation section PD, the user inputs the unit time production quantity information indicating the desired unit time production quantity into the input field F33. For example, when the user wants to designate the unit time production quantity for the target designated time period, the user inputs the designated time period information into the input field F32 and then inputs the unit time production quantity information indicating the desired unit time production quantity into the input field F33. FIG. 15 is a diagram showing an example of the reception image P4 immediately after the unit time production quantity information is input to the input field F33. In the example shown in FIG. 15, the target designated time period is the 19th time period. In the present example, the unit time production quantity indicating 480 pieces is input to the input field F33. When the input of the unit time production quantity information to the input field F33 is performed in this manner, the server 30 plots the histogram indicating the target unit time production quantity as the histogram of the 19th time period, which is the target designated time period. At this time, the server 30 causes display of the histogram of the target designated time period on the graph GP2 in a display mode different from the display mode of the histogram of the time period different from the target designated time period. In other words, the server 30 causes display of the histogram indicating the target unit time production quantity being edited on the graph GP2 in a display mode different from the display mode of the histogram of the time period different from the target designated time period. For example, the server 30 displays the histogram of the target designated time period on the graph GP2 in a color different from the color of the histogram of the designated time period different from the target designated time period. In the example shown in FIG. 15, such a difference in the color of the histogram is indicated by hatching. That is, in the present example, the histograms of the 14th time period to the 16th time period have the same color. On the other hand, in the present example, the color of the histogram of each of the 14th time period to the 16th time period is different from the color of the histogram of the 19th time period. By this, the server 30 can cause the user to visually recognize which of the 24 time periods the target designated time period is. As a result, the server 30 can suppress an erroneous operation on the reception image P4 by the user. FIG. 16 is a diagram showing an example of the reception image P4 immediately after the target designated time period is changed from the 19th time period to 20th time period in the reception image P4 shown in FIG. 15. In this case, since the target designated time period information does not indicate the 19th time period, the color of the histogram of each of the 14th time period to the 16th time period and the color of the histogram of the 19th time period becomes the same. That is, when the target designated time period is changed from the 19th time period to the 20th time period in the reception image P4 shown in FIG. 15, the server 30 changes the color of the histogram of the 19th time period to the same color as the color of each of the histograms of the 14th time period to the 16th time period. Note that the server 30 may be configured to change other display modes such as the shape of the histogram instead of the configuration to change the color of the histogram in this manner.

Note that in the reception image P4, the designation of the target designated time period by the time period designation section TD may be designated in units of one minute or designation in units of another time instead of designation in units of one hour.

The server 30 may be configured to cause the terminal device 40 to display a message warning that the unit time production quantity exceeding the unit time planning value has been input when at least one of the unit time production quantity indicated by the histograms displayed on the graph GP2 exceeds the unit time planning value.

Here, when the server 30 executes the plan allocation process after executing such an hourly production quantity designation process, for example, the server 30 reverts the state of the production plan creation image P3 to the state before performing all the processes performed in the hourly production quantity designation process and then executes the plan allocation process. By this, the user can easily revert the production plan that the user intended to create by the hourly production quantity designation process to the production plan created by the plan allocation process. Note that the server 30 may be configured to, when the hourly production quantity designation process is executed, not receive selection operation at button B32 in the production plan creation image P3. In this case, the server 30 can prevent the user from mistakenly deleting the production plan created by the hourly production quantity designation process.

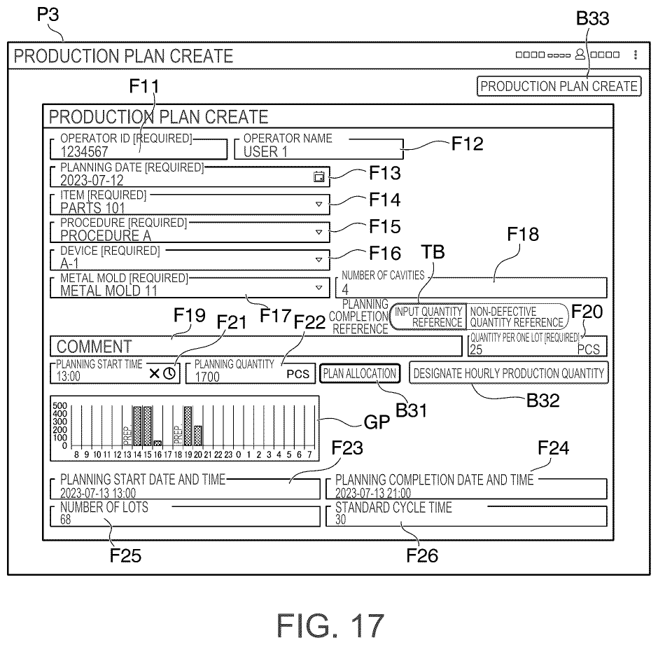

After the production plan information is generated by executing at least one of the plan allocation process and the hourly production quantity designation process described above, that is, after the plot of the histogram on the graph GP and the display of the inoperable time period on the graph GP are performed, the server 30 causes display of the button B33 on the production plan creation image P3 as shown in FIG. 17. FIG. 17 is a diagram showing an example of the production plan creation image P3 in a state where the button B33 is displayed.

The button B33 is a button for receiving an operation for storing the production plan information indicating the production plan indicated by the graph GP. When the server 30 receives the selection operation at the button B33, it stores the production plan information indicating the production plan indicated by the graph GP. Note that the storage format of the production plan information by the server 30 may be any format. After storing the production plan information, the server 30 deletes the display of the production plan creation image P3 from the terminal device 40. The production plan indicated by the production plan information stored in the server 30 can be displayed on the terminal device 40 by a reference function or the like included in the server 30. The reference function is, for example, the dashboard image or the like, but is not limited thereto.

As described above, the server 30 is communicably connected to the terminal device 40 and causes the terminal device 40 to display the graph GP as the production plan information indicating the production plan for the designated target product in response to the operation received from the terminal device 40. The graph GP, which is an example of the production plan information, includes a histogram, which is an example of the first operating time period information indicating the first operating time period in which the target injection molding device is operated in order to produce the target product and at least preparation time period information, which is an example of the inoperable time period information indicating the inoperable time period in which the target injection molding device cannot be operated in order to produce the target product. By this, the server 30 can provide a highly accurate production plan as compared with a production plan that does not include the time period indicated by the inoperable time period information.

Here, in the example described above, the preparation time period information is displayed as the inoperable time period information in the graph GP as described above. However, the graph GP may be configured to display other types of the inoperable time period information instead of the preparation time period information or in addition to the preparation time period information. Examples of other types of the inoperable time period information include a lunch break time period information indicating a time period in which lunch break, the second operating time period information indicating a second operating time period in which the target injection molding device is operated to produce a product different from the target product, a break time period information indicating a break time other than the lunch break, and a maintenance time period information indicating a time period in which maintenance of the target injection molding device is performed, but is not limited to these.

For example, the server 30 may be configured to store information indicating the lunch break time period in advance as information indicating the predetermined time period. In this case, during the plan allocation process, the server 30 causes the graph GP to display the lunch break time period information indicating that the time period indicated by the information stored in advance is the lunch break. In this case, the server 30 similarly performs such a process for the break time period information. When the server 30 stores in advance the production plan information indicating the production plan generated for a product different from the target product in the production plan creation image P3, may be configured to identify the second operating time period based on the production plan information stored in advance and cause display of the second operating time period information indicating the identified second operating time period on the graph GP. In this case, the server 30 performs such a process for the maintenance time period information in the same manner.

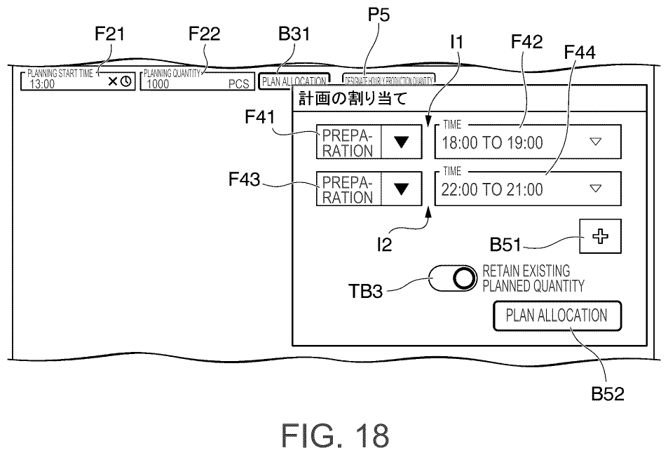

The server 30 may be configured to receive each of the lunch break time period information, the second operating time period information, the break time period information, and the maintenance time period information via an inoperable time period reception image P5 as shown in FIG. 18. In this case, the server 30 causes display of the inoperable time period information such as the lunch break time period information, the second operating time period information, the break time period information, and the maintenance time period information received via the inoperable time period reception image P5 in any of the plan allocation process and the hourly production quantity designation process on the graph GP.

FIG. 18 is a diagram showing an example of the inoperable time period reception image P5. In the example shown in FIG. 18, the inoperable time period reception image P5 includes an inoperable time period input section I1, an inoperable time period input section I2, a button B51, a toggle switch TB3, and a button B52.

The inoperable time period input section I1 is a GUI for receiving first inoperable time period information. The inoperable time period input section I1 has an input field F41 and an input field F42.

The input field F41 is an input field in which any one of the lunch break time period information, the second operating time period information, the break time period information, the maintenance time period information, and the like is input as the first inoperable time period information. The input of the first inoperable time period information to the input field F41 may be performed by a pull-down menu, may be performed by direct input using the keyboard or the like, or may be performed by another method. In the example shown in FIG. 18, input of the first inoperable time period information to the input field F41 is performed by the pull-down menu.

The input field F42 is an input field in which information indicating any one of the 24 time periods is input as the inoperable time period information indicated by the first inoperable time period information. The input of the information to the input field F42 may be performed by a pull-down menu, may be performed by direct input using the keyboard or the like, or may be performed by another method. In the example shown in FIG. 18, the input of the information to the input field F42 is performed by the pull-down menu.

The inoperable time period input section I2 is a GUI that receiving second inoperable time period information. The inoperable time period input section I2 has an input field F43 and an input field F44.

The input field F43 is an input field in which any one of the lunch break time period information, the second operating time period information, the break time period information, the maintenance time period information, and the like is input as the second inoperable time period information. The input of the second inoperable time period information to the input field F43 may be performed by a pull-down menu, may be performed by direct input using the keyboard or the like, or may be performed by another method. In the example shown in FIG. 18, input of the second inoperable time period information to the input field F43 is performed by the pull-down menu.

The input field F44 is an input field in which information indicating any one of the 24 time periods is input as the inoperable time period information indicated by the second inoperable time period information. The input of the information to the input field F44 may be performed by a pull-down menu, may be performed by direct input using the keyboard or the like, or may be performed by another method. In the example shown in FIG. 18, the input of the information to the input field F44 is performed by the pull-down menu.

The button B51 is a button for receiving an operation of adding the inoperable time period input section. When the selection operation is performed at button B51, the server 30 causes display of a GUI similar to each of the inoperable time period input section I1 and the inoperable time period input section I2 below the inoperable time period input section I2.

The toggle switch TB3 is a toggle switch that receives an operation of selecting either a first display mode in which a new graph GP is displayed and the two graphs GP are compared while maintaining the state of the current graph GP or a second display mode in which the new graph GP is displayed without maintaining the state of the current graph GP. When the server 30 receives the operation of selecting the first display mode via the toggle switch TB3, it changes the display mode of the toggle switch TB3 to a display mode indicating that the first display mode is selected. On the other hand, when the server 30 receives the operation of selecting the second display mode via the toggle switch TB3, it changes the display mode of the toggle switch TB3 to a display mode indicating that the second display mode is selected. These display mode of the toggle switch TB3 may be any mode as long as it is possible to distinguish whether the condition selected by the toggle switch TB3 is the first display mode or the second display mode. Here, the toggle switch TB3 shown in FIG. 18 indicates that the first display mode is selected.

The button B52 is a button for receiving an operation of displaying the inoperable time period information received via the inoperable time period input section such as the inoperable time period input section I1 or the inoperable time period input section I2 on the graph GP or the graph GP2. When the server 30 receives the selection operation at the button B52, it causes display of the inoperable time period information received via the inoperable time period input section such as the inoperable time period input section I1 or the inoperable time period input section I2 on the graph GP or the graph GP2.

Note that in the plan allocation process, the display of such the an inoperable time period reception image P5 is performed, for example, after the selection operation at the button B31 is performed, until the plot of the histogram to the graph GP is performed. In this case, when the selection operation is performed at the button B51, the server 30 plots the histogram on the graph GP and displays the inoperable time period information on the graph GP. On the other hand, in the hourly production quantity designation process, the inoperable time period reception image P5 is displayed together with the reception image P4. In this case, the inoperable time period reception image P5 may be configured integrally with the reception image P4, or may be configured separately from the reception image P4.

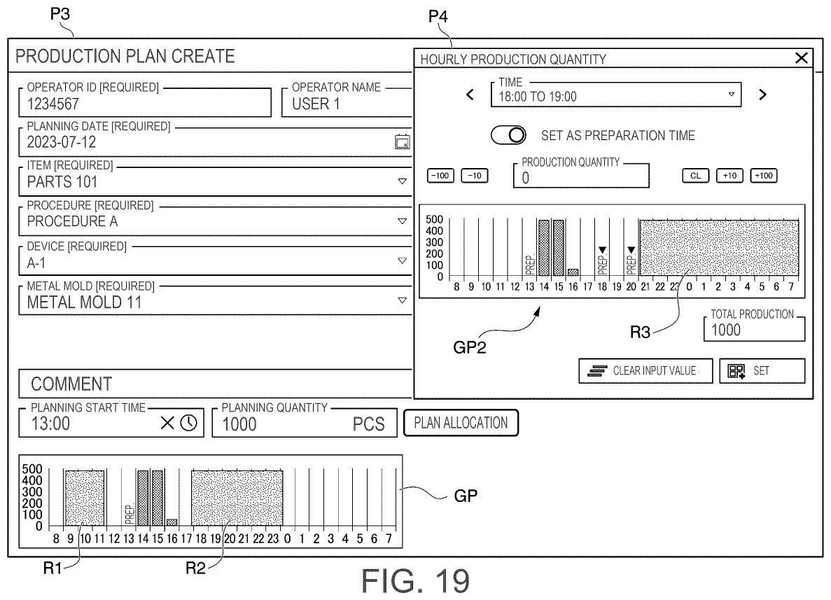

FIG. 19 is a diagram showing a state in which the second operating time period information is displayed on the graph GP and a state in which the second operating time period information is displayed on the graph GP2. Therefore, FIG. 19 shows each of a portion of the production plan creation image P3 including the graph GP and the reception image P4.

In the graph GP included in the production plan creation image P3 shown in FIG. 19, two pieces of second operating time period information, which are second operating time period information R1 and second operating time period information R2, are displayed. The second operating time period information R1 indicates the time period of the 9th time period to the 11th time period as the second operating time period. The second operating time period information R2 indicates the time period of the 18th time period to the 23rd time period as the second operating time period. These two pieces of second operating time period information are displayed on the graph GP in a display mode different from the display mode of the histogram plotted on the graph GP. In the example shown in FIG. 19, these two pieces of second operating time period information are displayed on the graph GP in a color different from the color of the histogram plotted on the graph GP. Note that in FIG. 19, such a difference in the color is indicated by hatching. By this, the server 30 can cause the user to visually distinguish the first operating time period information and the second operating time period information in the graph GP. As a result, the server 30 can prevent the user from causing duplication of the production plan for operating the target injection molding device.

On the other hand, the graph GP2 included in the reception image P4 shown in FIG. 19 displays second operating time period information R3. The second operating time period information R3 indicates an operating time period of the 22nd time period to the 7th time period as the second operating time period. The second operating time period information R3 is displayed in the graph GP2 in a display mode different from the display mode of the histogram plotted in the graph GP2. In the example shown in FIG. 18, the second operating time period information R3 is displayed in the graph GP2 in a color different from the color of the histogram plotted in the graph GP2. Note that in FIG. 19, such a difference in the color is indicated by hatching. By this, the server 30 can cause the user to visually distinguish the first operating time period information and the second operating time period information in the graph GP2. As a result, the server 30 can prevent the user from causing duplication of the production plan for operating the target injection molding device.

As described above, the server 30 for generating the production plan information indicating the production plan is, for example, a workstation, a desktop Personal Computer (PC), a notebook PC, or the like, but is not limited to these. The server 30 may be configured integrally with the information process device 20.

The server 30 is communicatively connected to the information process device 20 by communication via a wire or wireless. The communication network connecting the server 30 and the information process device 20 may be, for example, the LAN in the facility where multiple managed devices 10 are installed, may be the Internet, may be a mobile communication network, or may be another communication network. Hereinafter, as an example, a case where the communication network connecting the server 30 and the information process device 20 is the Internet will be described. In this case, the server 30 is a cloud server.

The server 30 is communicatively connected to the terminal device 40 by communication via a wire or wireless. In the example shown in FIG. 1, the server 30 is communicably connected to the terminal device 40 by wireless communication. The communication network connecting the server 30 and the terminal device 40 may be, for example, the LAN in the facility where the server 30 is installed, may be the Internet, may be the mobile communication network, or may be another communication network. Hereinafter, as an example, a case where the communication network connecting the server 30 and the terminal device 40 is the Internet will be described.

### Hardware Configuration of Server

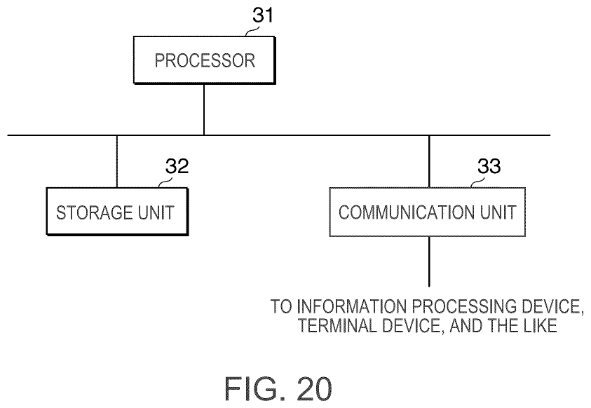

Hereinafter, the hardware configuration of the server 30 will be described below with reference to FIG. 20. FIG. 20 is a diagram showing an example of a hardware configuration of a server 30.

The server 30 includes, for example, a processor 31, a storage section 32, and a communication section 33. These components are communicably connected to each other via a bus. The server 30 communicates with each of the information process device 20 and the terminal device 40 via the communication section 33.

The processor 31 is, for example, a Central Processing Unit (CPU). Note that the processor 31 may be another processor such as a Field Programmable Gate Array (FPGA) instead of the CPU. The processor 31 executes various programs stored in the storage section 32.

The storage section 32 is a storage device including, for example, a Hard Disk Drive (HDD), a Solid State Drive (SSD), an Electrically Erasable Programmable Read Only Memory (EEPROM), a Read Only Memory (ROM), and a Random Access Memory (RAM). Note that the storage section 32 instead of being built into the server 30, may be an external storage device connected by a digital input-output port such as Universal Serial Bus (USB). The storage section 32 stores various information, various images, and various programs processed by the server 30.

The communication section 33 is a communication device configured to include, for example, the digital input/output port such as the USB, an Ethernet (R) port, and an antenna for wireless communication.

### Functional Configuration of Server

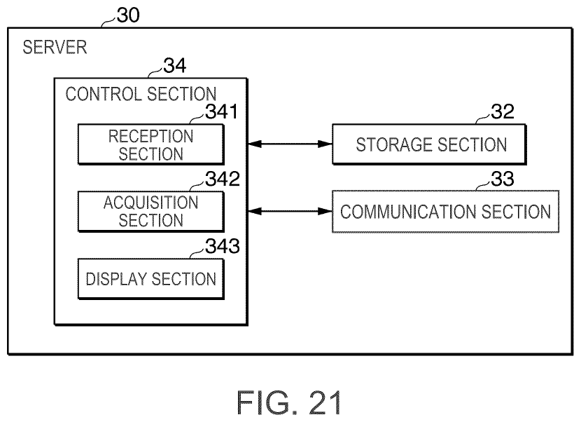

Hereinafter, the functional configuration of the server 30 will be described with reference to FIG. 21. FIG. 21 is a diagram showing an example of the functional configuration of the server 30.

The server 30 includes the storage section 32, the communication section 33, and the control section 34.

The control section 34 controls the entire server 30. The control section 34 includes a reception section 341, an acquisition section 342, and a display control section 343. These functional units included in the control section 34 are realized, for example, by the processor 31 executing various programs stored in the storage section 32. Some or all of the functional sections may be hardware functional sections such as a Large Scale Integration (LSI) and an Application Specific Integrated Circuit (ASIC).

The reception section 341 receives various kinds of information and various kinds of operations from a device communicably connected to the server 30.

The acquisition section 342 acquires, for each of the plurality of managed devices 10, the state information for the managed device 10 from the managed device 10 via the information process device 20. The acquisition section 342 may be configured to acquire the state information directly from the managed device 10 without using the information process device 20.

The display control section 343 generates various types of images according to operations received via the reception section 341. The display control section 343 transmits the generated image to the terminal device 40 and causes the terminal device 40 to display the image.

### Process of Generating Production Plan Information by Server

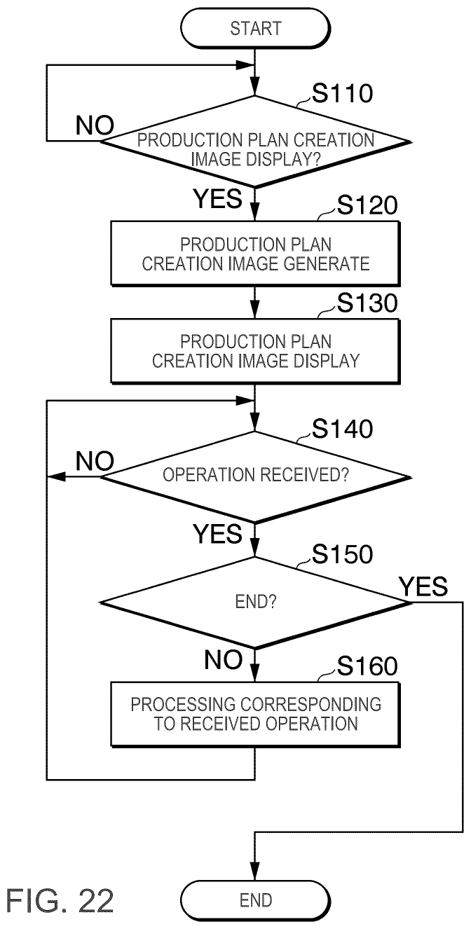

The process by which the server 30 generates the production plan information will be described with reference to FIG. 22. FIG. 22 is a diagram showing an example of a flow of process in which the server 30 generates the production plan information. Hereinafter, as an example, a case where the terminal image P2 is displayed on the terminal device 40 at the time before the process of step S110 is shown in FIG. 22 is performed will be described. Hereinafter, as an example, a case where the master data is already stored in the server 30 at the time will be described.

The control section 34 waits until an operation for displaying the production plan creation image P3 is received via the terminal device 40 (step S110).

When the control section 34 determines that the operation of displaying the production plan creation image P3 is received via the terminal device 40 (YES in step S110), the control section 34 generates the production plan creation image P3 (step S120). The method of generating the production plan creation image P3 in step S120 may be a known method or a method to be developed.

Next, the control section 34 transmits the production plan creation image P3 generated in step S120 to the terminal device 40 and causes the terminal device 40 to display the production plan creation image P3 (step S130).

Next, control section 34 waits until an operation is receives via the production plan creation image P3 displayed on the terminal device 40 (step S140).

When it is determined that the operation has been received via the production plan creation image P3 displayed on the terminal device 40 (YES in step S140), the control section 34 determines whether or not the received operation is an operation for ending the processing of the flowchart shown in FIG. 22 (step S150). The determination process of step S150 by the control section 34 may be performed by a known method or a method to be developed.

When the control section 34 determines that the operation received in step S140 is the operation for ending the process of the flowchart shown in FIG. 22 (YES instep S150), the control section 34 deletes, for example, the display of the production plan creation image P3 from the terminal device 40, and ends the process of the flowchart shown in FIG. 22.

On the other hand, when the control section 34 determines that the operation received in step S140 is not the operation for ending the process of the flowchart shown in FIG. 22 (No in step S150), the control section 34 performs process corresponding to the received operation (step S160). Here, since process performed by the control section 34 in step S160 has been described in the description of FIG. 4 to FIG. 19, a detailed description thereof will be omitted.

After process of step S160 is performed, the control section 34 proceeds to step S140 and waits again until the operation is received via the production plan creation image P3 displayed on the terminal device 40.

By process as described above, the server 30 generates, for example, the graph GP, which is an example of the production plan information in response to the operation received via the production plan creation image P3. By this, the server 30 can provide a highly accurate production plan.

Note that the molding management system 1 described above may be configured to include the terminal device 40.

The contents described above may be combined in any manner.

### APPENDICES

[1] A molding management system including a server and managing production of a product in a production process including an injection molding process of the product by an injection molding device, wherein the server is communicably connected to a terminal device and configured to cause the terminal device to display production plan information indicating a production plan for a designated first product in response to an operation received from the terminal device and the production plan information includes first operating time period information indicating a first operating time period in which the injection molding device is operated to produce the first product and inoperable time period information indicating at least an inoperable time period during which the injection molding device cannot be operated to produce the first product.
[2] The molding management system according to [1], wherein the inoperable time period information includes at least preparation time period information from among preparation time period information, which indicates a preparation time period for performing preparation for operating the injection molding device to produce the first product, and second operating time period information, which indicates a second operating time period for operating the injection molding device to produce a second product different from the first product.
[3] The molding management system according to [1] or [2], wherein the server is configured to receive production capacity information indicating a production capacity of the injection molding device for the production of the first product and is configured to cause the terminal device to display, based on the received production capacity information, unit time production quantity planned value information indicating a planned value of a production quantity of the first product per unit time by the injection molding device.
[4] The molding management system according to [3], wherein the production capacity information includes number of cavities information indicating a number of cavities of the injection molding device for the production of the first product and standard cycle time information indicating a standard cycle time of the injection molding device for the production of the first product.
[5] The molding management system according to any one of [1] to [4], wherein the server is configured to cause the terminal device to display a reception image for receiving production plan related information related to the production plan in response to a received operation and is configured to cause the terminal device to display, based on the production plan related information received via the reception image, the production plan information.
[6] The molding management system according to [5], wherein the reception image includes a time period designation section that receives an operation of designating a time period and a production quantity designation section that receives an operation of designating the production quantity of the first product by the injection molding device in the time period designated by the time period designation section, the production quantity designation section includes an input field to which information indicating the production quantity of the first product by the injection molding device in the time period designated by the time period designation section is input and an image for receiving an operation for increasing or decreasing the production quantity indicated by the information input in the input field by a predetermined quantity, and the time period designated by the time period designation section and the production quantity designated by the production quantity designation section are information included in the production plan related information.
[7] The molding management system according to [6], wherein the server is configured to cause the terminal device to display production quantity information indicating the production quantity designated by the production quantity designation section as the planned value of the production quantity of the first product by the injection molding device in the time period designated by the time period designation section and the display mode of the production quantity information differs depending on whether or not the production quantity designated by the production quantity designation section is being edited in the time period designated by the time period designation section.
[8] The molding management system according to any one of [1] to [7], wherein the server is configured to cause the terminal device to display a production planning start time reception image for receiving a production planning start time that indicates a start time of the production plan, is configured to receive the production planning start time via the production planning start time reception image displayed on the terminal device, and is configured to cause the terminal device to display, based on the received production planning start time, the production plan information.
[9] The molding management system according to [8], wherein the display state of the production planning start time reception image changes in accordance with the received operation and the time associated with each display state of the production planning start time reception image is received as the production planning start time.
[10] The molding management system according to any one of [1] to [9], further includes the terminal device.
[11] The molding management system according to any one of [1] to [10], further includes the injection molding device.

Although the embodiments of the present disclosure have been described in detail with reference to the drawings, specific configurations are not limited to the embodiments, and changes, substitutions, deletions, and the like may be made without departing from the gist of the present disclosure.

A program for realizing a function of an arbitrary configuration section in the device described above may be recorded in a computer-readable recording medium, and the program may be read and executed by a computer system. Here, the device is, for example, the injection molding device 11, the information process device 20, the server 30, the terminal device 40, or the like. Note that the term “computer system” as used herein includes an Operating System (OS) and hardware such as peripheral devices. The “computer-readable recording medium” refers to a portable medium such as a flexible disk, a magneto-optical disk, a ROM, or a Compact Disk (CD)-ROM, or a storage device such as a hard disk built in the computer system. Further, “computer-readable recording medium” includes a medium that holds a program for a certain period of time, such as a volatile memory inside a computer system serving as a server or a client when the program is transmitted via a network such as the Internet or a communication line such as a telephone line.

The program may be transmitted from the computer system in which the program is stored in the storage device or the like to another computer system via a transmission medium or by a transmission wave in the transmission medium. Here, “transmission medium” for transmitting the program refers to a medium having a function of transmitting information such as a network such as the Internet or a communication line such as a telephone line.

The above described program may be a program for realizing a part of the above described functions. Further, the above described program may be a so-called difference file or difference program that can realize the above described functions in combination with a program already recorded in the computer system.

What is claimed is:

1. A molding management system including a server and managing a production of a product in a production process including an injection molding process of the product by an injection molding device, wherein
the server is communicably connected to a terminal device and configured to cause the terminal device to display production plan information indicating a production plan for a designated first product in response to an operation received from the terminal device and
the production plan information includes first operating time period information indicating a first operating time period in which the injection molding device is operated to produce the first product and inoperable time period information indicating at least an inoperable time period during which the injection molding device cannot be operated to produce the first product.

2. The molding management system according to claim 1, wherein
the inoperable time period information includes at least preparation time period information from among preparation time period information, which indicates a preparation time period for performing preparation for operating the injection molding device to produce the first product, and second operating time period information, which indicates a second operating time period for operating the injection molding device to produce a second product different from the first product.

3. The molding management system according to claim 1, wherein
the server is configured to receive production capacity information indicating a production capacity of the injection molding device for the production of the first product and is configured to cause the terminal device to display, based on the received production capacity information, unit time production quantity planned value information indicating a planned value of a production quantity of the first product per unit time by the injection molding device.

4. The molding management system according to claim 3, wherein
the production capacity information includes number of cavities information indicating a number of cavities of the injection molding device for the production of the first product and standard cycle time information indicating a standard cycle time of the injection molding device for the production of the first product.

5. The molding management system according to claim 1, wherein
the server is configured to cause the terminal device to display a reception image for receiving production plan related information related to the production plan in response to a received operation and is configured to cause the terminal device to display, based on the production plan related information received via the reception image, the production plan information.

6. The molding management system according to claim 5, wherein
the reception image includes a time period designation section that receives an operation of designating a time period and a production quantity designation section that receives an operation of designating the production quantity of the first product by the injection molding device in the time period designated by the time period designation section,
the production quantity designation section includes an input field to which information indicating the production quantity of the first product by the injection molding device in the time period designated by the time period designation section is input and an image for receiving an operation for increasing or decreasing the production quantity indicated by the information input in the input field by a predetermined quantity, and
the time period designated by the time period designation section and the production quantity designated by the production quantity designation section are information included in the production plan related information.

7. The molding management system according to claim 6, wherein
the server is configured to cause the terminal device to display production quantity information indicating the production quantity designated by the production quantity designation section as the planned value of the production quantity of the first product by the injection molding device in the time period designated by the time period designation section and
the display mode of the production quantity information differs depending on whether or not the production quantity designated by the production quantity designation section is being edited in the time period designated by the time period designation section.

8. The molding management system according to claim 1, wherein
the server is configured to cause the terminal device to display a production planning start time reception image for receiving a production planning start time that indicates a start time of the production plan, is configured to receive the production planning start time via the production planning start time reception image displayed on the terminal device, and is configured to cause the terminal device to display, based on the received production planning start time, the production plan information.

9. The molding management system according to claim 8, wherein
the display state of the production planning start time reception image changes in accordance with the received operation and the time associated with each display state of the production planning start time reception image is received as the production planning start time.

10. The molding management system according to claim 1, further comprising:
the terminal device.

11. The molding management system according to claim 1, further comprising:
the injection molding device.
